(19) United States
(12) Patent Application Publication
(10) Pub. No.: US 2011/0238763 A1
(43) Pub. Date: Sep. 29, 2011

(54) Social Help Network

(75) Inventors: Jae Whan Shin, Campbell, CA (US); Zhiping Zheng, Irvine, CA (US)

(73) Assignee: Momo Networks, Inc., Campbell, CA (US)

(21) Appl. No.: 13/036,052

(22) Filed: Feb. 28, 2011

Related U.S. Application Data
(60) Provisional application No. 61/308,298, filed on Feb. 26, 2010.

(51) Int. Cl. G06F 15/16

(52) U.S. Cl. 709/206

(57) ABSTRACT

A help item is received from a first user by using a social help network. The help item indicates a help service to be performed for the first user by a second user of the social help network, or by the first user for the second user. Factor(s) of the first user and other users of the social network are determined, such as a geographical location of each user. Factor(s) of the help item are determined, such as a geographical location where the help service is to be performed. Based on the factor(s) of each of the first user, the help item, and the other users, a search for potential second users is performed. Each potential second user can perform the help service for the first user, or each potential second user can have the help service performed by the first user.

### PRIORITY CLAIM

This application claims benefit of priority of (and incorporates by reference) U.S. provisional Patent Application Ser. No. 61/308,298 titled “A Social Network System for a Help Service,” filed Feb. 26, 2010, whose named inventor is Jae Whan Shin.

### FIELD OF THE INVENTION

The present invention relates to social networks, and more particularly to social help networks that facilitate communication between its users.

### BACKGROUND OF THE INVENTION

A computer-based social network (“social network”) is a network that enables its users to create and maintain social relations with other users with whom they may share similar interests, beliefs, relationships, activities, etc. A social network typically provides a representation of each user (e.g., via a profile page), his/her social links, and/or a variety of additional services. Most social networks are web-based and enable users to interact with each other via the internet. For instance, users may post comments on their own profile pages and/or other users' profile pages, use e-mail and/or instant messaging, and so on. Some examples of web-based social networks include Facebook®, MySpace®, Twitter®, LinkedIn®, etc.

Specifically, social networks enable a user to interact with other users who are members of network of that user. These other users are often referred to as “connections” of the user. For example, a network may be any group of persons, including a group of friends, business associates, players of a massively multiplayer online game, persons with a common interest, users of a social network/application/web site, and/or a subgroup of a social network. A user may belong to any number of networks. Members of a social network may be able to search for other users in his or her network, or outside the network, by their names and/or other characteristics of the users, such as a designated interest, location, and/or job position.

There are some user generated review sites, such as Yelp®, as well as social networks that may provide help suggestions to users, such as Aadvard®, Mahalo®, etc. However, all of these have various limitations as far as proving relevant, proper, and/or timely help to users.

### SUMMARY OF THE INVENTION

Various approaches are described herein for, among other things, searching for potential user(s) that can perform a help service for a user or that can have a help service performed by a user. The methods for a social help network described herein leverage mobile and internet platforms to broadcast and deliver help items, such as help offers/requests, and in general connect people that request help with people who can provide the requested help. The social help network can also facilitate messaging between its users in real time, such as messaging regarding the help item. The conversation topic and/or any help item requirements may dynamically change as the conversation continues.

The social help network has a geo-location intelligence attached to each help item. Each help item can be considered as an independent customized commodity which evolves with time and participants involved. The help item may be a service, a product, knowledge, and a monetary and/or material resource. The social help network may rank its users as well as each help item (e.g., request and offer) to evaluate its viability in the market place. The social help network may use a search algorithm that reflects this ranking system, e.g., in order to minimize any potential statistical errors. Thus, the social help network can facilitate, manage, and connect those who need help and those who can help.

One exemplary embodiment for operating the social help network is described. In accordance with this exemplary embodiment, a help item is received from a first user through a social help network. The help item indicates a help service that is to be performed for the first user by a second user or by the first user for the second user. The social help network includes a plurality of users including the first user and potential second users that include the second user. One or more factors of the first user are determined. One or more factors of the help item are determined. One or more factors of a subset of the users are determined. Based on the factor(s) of each of the first user, the help item, and users in the subset, a search for potential second users is performed. Each potential second user can perform the help service indicated by the help item for the first user. Alternatively, each potential second user can have the help service performed by the first user.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram illustrating elements of an exemplary network system in which embodiments of the present invention may be implemented.

FIG. 2 is a flowchart of a method for operating a social help network, according to one or more embodiments.

FIGS. 3A-3B are block diagrams of exemplary social help network modules, according to one or more embodiments.

FIG. 4 is another block diagram of an exemplary social help network module, according to one or more embodiments.

FIG. 5 is a block diagram showing interactions between various modules of a social help network module, according to one or more embodiments.

FIGS. 6A-B show a table illustrating an exemplary ranking system as used by the social help network, according to one or more embodiments.

FIGS. 7A-D are exemplary screenshots of a mobile application that can be used by users of the social help network, according to one or more embodiments.

FIGS. 8A-M are exemplary screenshots of an application that can be used by users of the social help network, according to one or more embodiments.

FIG. 9 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The following detailed description refers to the accompanying drawings that illustrate example various embodiments of the present invention. However, the scope is not limited to these embodiments, e.g., it is instead defined by the appended claims. Thus, various embodiments beyond those shown in the accompanying drawings, such as modified versions of the illustrated embodiments, may nevertheless be encompassed by the present invention.

References in the specification to “one embodiment,” “an embodiment,” “an example embodiment,” “one or more embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment(s). Furthermore, when a particular feature, structure, or characteristic is described in connection with embodiment(s), it is submitted that it is within the knowledge of one skilled in the art to implement such feature, structure, or characteristic in connection with other embodiment(s) whether or not explicitly described.

A social network system for help services (also referred to as a social help network) described herein operates to connect users requesting help with users that can provide help. The social help network can leverage various user platforms, including mobile and internet platforms, to broadcast and deliver help requests from users, thus connecting people that request help with people who can provide the requested help. The social help network can also facilitate messaging between its users in real time, such as by providing chatting facilities between users, as well as provide a “robot” that can answer some questions such as by using a natural language question and answer system. The conversation topics and requirements for the messaging/chatting may be in constant mutation as the conversation continues in chatting format, so the social help network may utilize real-time, or near real-time, indexing and responsiveness.

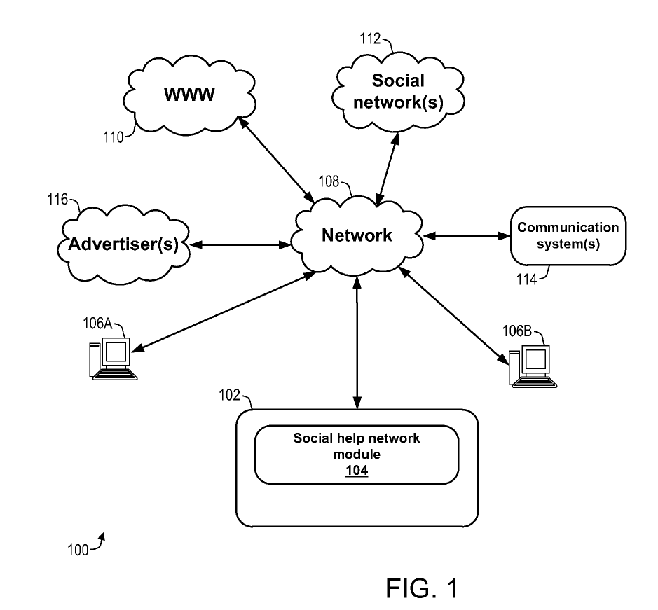

FIG. 1 is a block diagram illustrating elements of an exemplary network system 100 in which embodiments of the present invention may be implemented. System 100 is described herein for illustrative purposes only, and it is noted that embodiments of the present invention may be implemented in alternative environments. As shown in FIG. 1, system 100 includes one or more servers 102 that can include a social help network module 104. Specifically, social help network module 104 may be implemented in hardware, software, firmware, or any combination thereof. For example, one or more of servers 102 can host a social help network, including implementing social help network module 104.

One or more user systems, such as a user system 106A and a user system 106B, are connected to a communication network 108. Network 108 may be any type of a communication network, such as a local area network (LAN), a wide area network (WAN), or a combination of these and/or other communication network(s). Network 108 may include the Internet, and it may be connected to a World Wide Web (WWW) 110. Network 108 may also be connected to one or more social networks 112, such as Facebook, LinkedIn, etc. Network 108 may also facilitate communication with communication systems 114, such as mobile/cellular telephone systems, email systems, instant messaging systems, etc. Network 108 may also facilitate communication with one or more advertisers 116 that may provide advertisements, such as by providing advertisements to be displayed on web pages that are viewed by user(s).

In one embodiment, social help network module 104 can implement a social help network that allows its users to create and maintain social relations with other users with whom they may share similar interests, beliefs, relationships, activities, etc. The social help network provides a representation of each user (e.g., via a profile page), his/her social links, and/or a variety of additional services. The social help network can be web-based and enables its users to interact with each other via the internet. For instance, users may post comments on their own profile pages and/or other users' profile pages, use e-mail and/or instant messaging, and so on.

Specifically, a social help network may enable a user to interact with other users who are members of a network of that user (i.e., “connections” of that user). For example, a network may be any group of persons, including a group of friends, business associates, players of a massively multiplayer online game, persons with a common interest, users of a social network/application/web site, and/or a subgroup of a social network. A user may belong to any number of networks. Members of the social help network may be able to search for other users in his or her network, or outside the network, by their names and/or other characteristics of the users, such as a designated interest, location, and/or job position. Members of the social help network may also reach other users in the network through an intermediary, such as a common friend or a third person who has both the first and second user as his personal contacts in the network.

In one embodiment, social help network module 104 can match a help item that is submitted by a first user (i.e., a social help network representation a physical user of first user system 106A) to a second user (e.g., a social help network representation a physical user of second user system 106A). The help item may be a request for a help service to be performed for the first user, or it may be a proposal for a help service to be performed by the first user. Social help network module 104 can search for potential second users (i.e., users that may have use for the help item) out of the users of the social help network based on factors of the first user, factors of the help item, and factors of at least some of the other users.

The manner in which social help network module 104 searches for potential second users that each can perform the help service indicated by the help item for the first user or for one or more potential second users for whom the first user can perform the help service indicated by the help item will be described in more detail below.

Social help network module 104 may be implemented in hardware, software, firmware, or any combination thereof. For example, social help network module 104 may include software/firmware that executes in one or more processors of one or more computer systems, such as one or more servers.

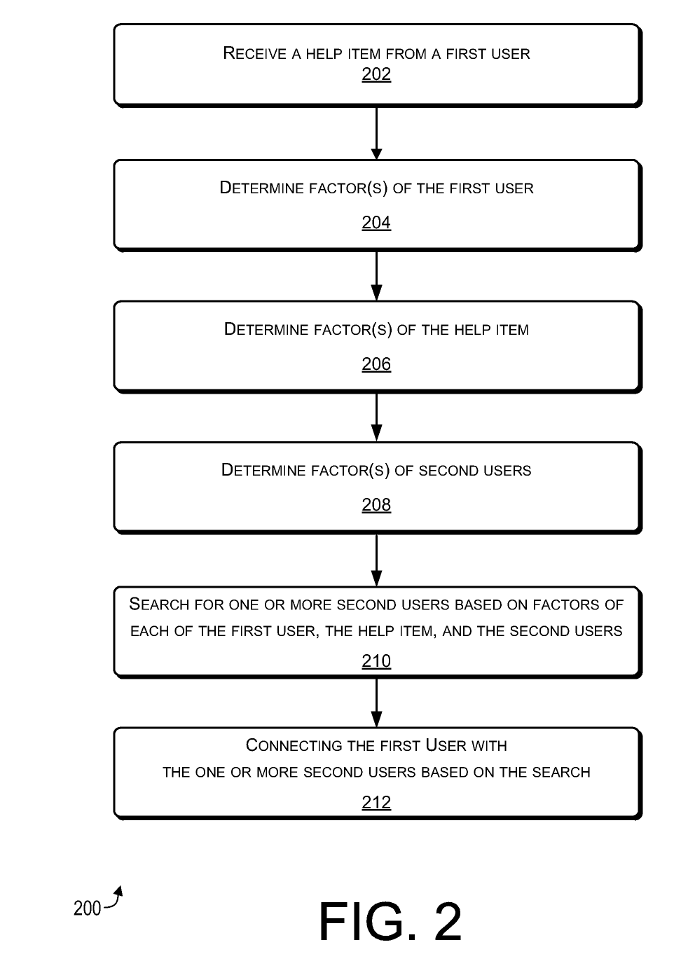

FIG. 2 depicts a flowchart 200 of a method for operating a social help network in accordance with one or more embodiments. The method of flowchart 200 will be described in reference to elements of system 100. However, it is noted that the method is not limited to that implementation. Also, the method of flowchart 200 may be modified by those skilled in the art in order to derive alternative embodiment(s). Also, the steps may occur in a different order than shown, some steps may be performed concurrently, some steps may be combined with other steps, and/or some steps may be absent, as desired.

As shown in FIG. 2, the method of flowchart 200 begins at step 202 in which social help network module 104 receives a help item from a first user. Social help network module 104 may facilitate communication of the help item via a social help network. The social help network includes a plurality of users including the first user and a plurality of potential second users that includes the second user. Social help network module 104 can receive the help item such as by the first user posting the help item on the social help network. However, social help module may receive the help item in other ways, such as by other communication means, including email, social networks, etc.

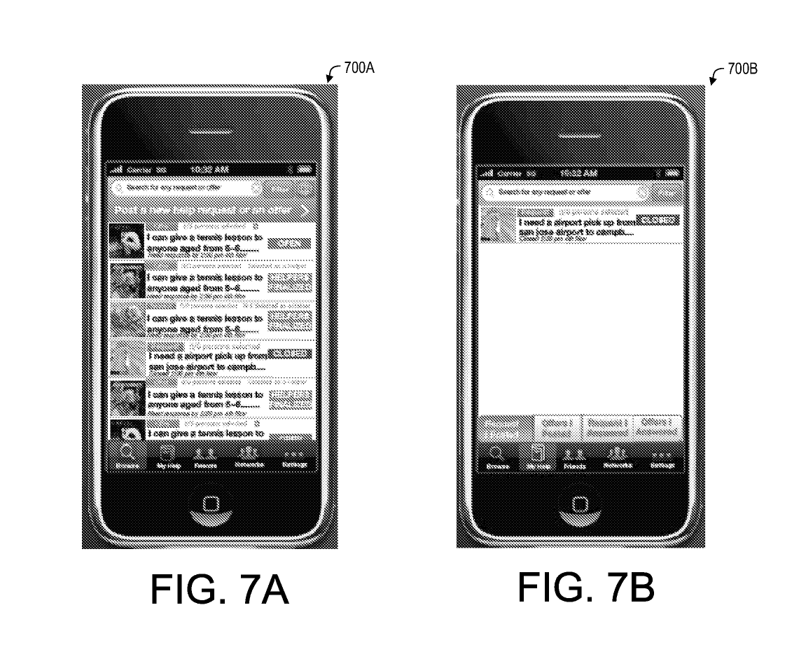

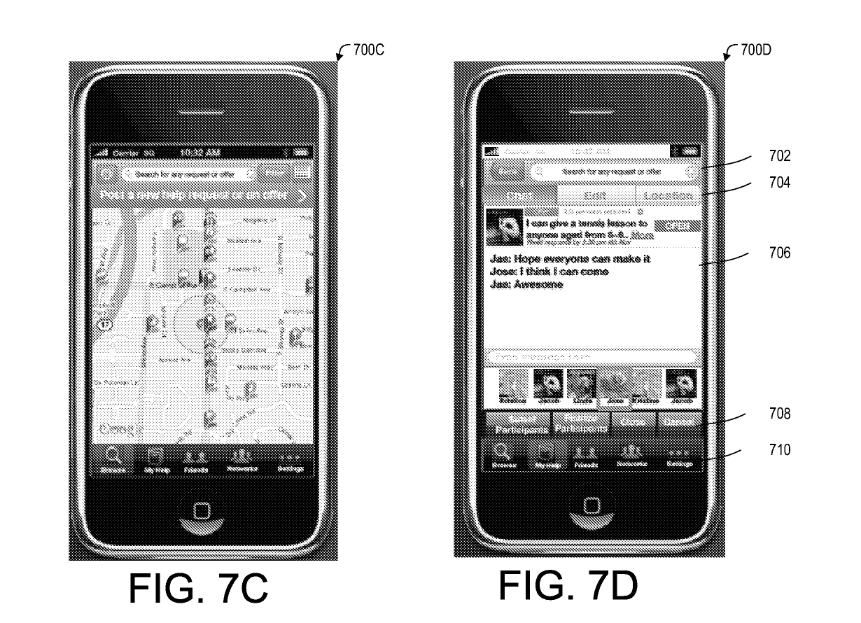

The help item indicates a help service that is to be performed for the first user by a second user, such as a request for help. Alternatively, help item indicates a help service that is to be performed by the first user for the second user, such as a proposal for help. In one embodiment, the help item can be a data structure that can have various attributes that may characterize the when, where, who, how, why, for whom, price (bid) information about the help item (e.g., a help service). These attributes of the help item may be used to determine factors of that data item. The social help network may allow its users to post and reply to help items, search for help items (e.g., for date, bid, geographical location, etc.), among other functions, such as by applications and mobile apps (e.g., as illustrated in FIGS. 7A-D and 8A-M). In one embodiment, the social help network creates a marketplace for help items, which can be searched on, traded, posted, fulfilled, etc., using various applications.

In one embodiment, the first user can receive communication from another user via the social help network regarding the help item. This communication may be an instant message (IM), a post using the social help network and/or other social networks, email, etc. This communication may include information on the help item, such as a change in one of the factors of that help item. Social help network module 104 may automatically modify one more of the factor(s) of the help item in response to receiving this communication. For example, social help network module 104 may gather contents of this communication and automatically modify one of the factors of the help item as needed.

At step 204, social help network module 104 determines one or more factors of the first user. The factor(s) of the first user may include a geographical location of the first user, e.g., where the first user is located. The factor(s) of the first user may include profile information, such as that of the social help network. The factor(s) of the first user may include a trust worthiness score indicative of at least how active the first user is in the social help network. The factor(s) may also include previously posted help items by the first user.

At step 206, social help network module 104 determines one or more factors of the help item. The factors of the help item may include a geographical location of the help service to be performed. For example, the help item may include a factor that indicates that the help service needs to be performed in Austin, Tex. Help items such as help requests may include a more precise requirement where the help service needs to be performed (e.g., by a second user). Alternatively the help item may include a factor that indicates a less precise area, such as in a help offer. In this case, the geographical location factor may be determined to be an area, such as central Texas, etc.

The factors of the help item may include a bid for the help item that indicates a desired value for the help service. The bid may be later negotiated, as desired, by the first user and the second user. The factors of the help item may include a title of the help item, which may be used to categorize the help item. The factors of the help item may include a description of the help service. The factors of the help item may also include one or more requirements of the help service to be performed. The requirements may specify various parameters, such as desired time/date when the help service should be performed, any physical characteristics of the help service, etc.

At step 208, social help network module 104 determines one or more factors of at least a subset of the plurality of users. Similarly to the factors of the first user, the factors of the users may include profile information and geographical location of each user. The factors of the users may include a trust worthiness score indicative of at least how active each user is in the social help network. The factors of the user may include previously posted help items by each user. In addition, the factors of the users may include strength of a social network relationship to the first user. The strength of a social network relationship may indicate whether a particular user has many social network connections to the first user (in the social help network and/or other social networks).

At step 210, social help network module 104 searches for one or more potential second users that each can perform the help service indicated by the help item for the first user or for one or more potential second users for whom the first user can perform the help service indicated by the help item. This search is based on the factor(s) of the first user, the factor(s) of the help item, and the factor(s) of the subset of users.

In one embodiment, social help network module 104 may rank at least a subset of the users based on relations between factor(s) of the first user, of the help item, and of the users. The ranking process will be described in more detail below. In one embodiment, ranking can account for proximity of respective geographical location of the first user, where the help service is to be performed, and each user. The highest ranked user(s) (i.e., that have a higher ranking relative to other users) may be presented to the first user. The first user may then select a second user out of the highest ranked users, e.g., to perform the help service.

In step 212, social help network module 104 connects the first user with the one or more second users based on the searching for the potential second users (e.g., that was performed in step 210). Social help network module 104 can then inform the first user of the potential second user(s) that can each perform the help service. Alternatively, social help network module 104 can inform the potential second user(s) of the first user and of the help service to be performed.

In one embodiment, social help network module 104 can display a map showing geographical locations of at least a subset of the plurality of users to the first user. Social help network module 104 can then receive a selection from the first user indicating the second user from the displayed map of the closest users.

In one embodiment, social help network module 104 can filter out a subset of users from the plurality of users. Each user in this subset of users may have a social relationship score that is below a social threshold. The social relationship score for each user may be indicative of a strength of a social tie in one or more of the social help network or other social networks between that user and the first user.

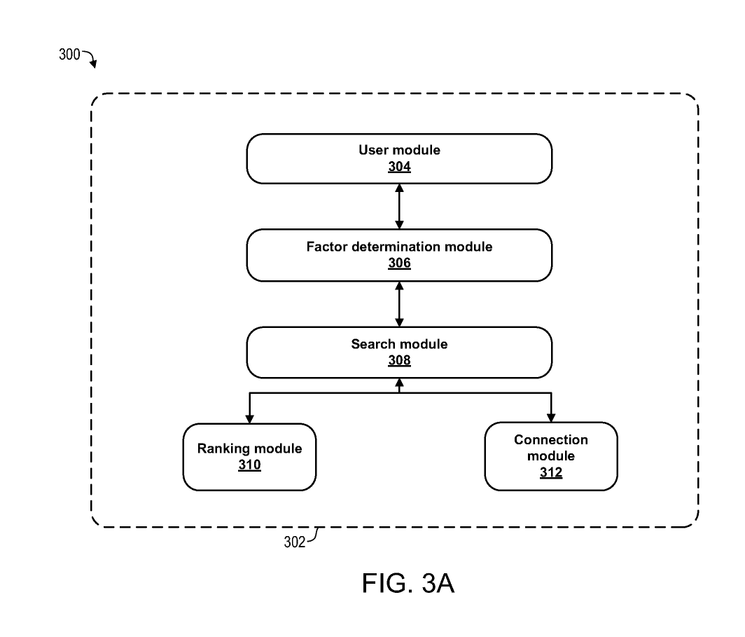

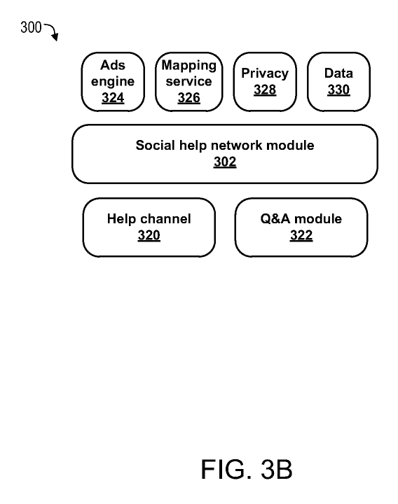

FIG. 3A is a block diagram 300 of an exemplary social help network module 302, according to one or more embodiments. Social help network module 302 is an example implementation of social help network module 104 of FIG. 1. As shown, social help network module 302 includes a user module 304, a factor determination module 306, a search module 308, a ranking module 310, and a connection module 312.

User module 304 is operable to receive a help item from a first user via a social help network. User module 304 is also operable to present to the first user one or more highest ranked users (such as ranked by ranking module 310) that have a higher ranking relative to other users based on said ranking.

Factor determination module 306 is operable to determine one or more factors of the first user including a geographical location of the first user. Factor determination module 306 is operable to determine one or more factors of the help item including a geographical location where the help service is to be performed. Factor determination module 306 is also operable to determine one or more factors of at least a subset of the plurality of users including a geographical location of each of the subset of users.

Search module 308 is operable to search, based on the factor(s) of the first user, the factor(s) of the help item, and the factor(s) of the subset of users, for one or more potential second users that each can perform the help service indicated by the help item for the first user or for one or more potential second users for whom the first user can perform the help service indicated by the help item.

Ranking module 310 is operable to rank each of at least a subset of the users based on a relation between one or more of the factor(s) of the first user, factor(s) of the help item, or factor(s) of each factors of at least a subset of the users. In one embodiment, ranking module 310 may evaluate both the credibility of potential help providers and the relationship of the potential help providers to the help requestor to rank the potential help providers (i.e., potential second users) to answer a question/help request (help item).

The social help network may have several degrees for network relationships. The first degree network (i.e., users that are direct contacts with the help requestor) usually is a good starting point of finding people who are most likely be able to provide an answer. As the network extends to 2nd degree (i.e., users that are contacts of the direct contacts of the help requestor) and further, more candidates become available, yet less weight may be given to the relationship to the help requestor. So the higher the credibility and the closer the relationship, the higher ranking may be given to the user to answer the request, and higher the ranking of the answer itself. The ranking of the user is also used when social help network tries to find a user who can answer a request.

Connection module 312 is operable to connect the first user with the potential second user(s) based on results of the search for the potential second user(s). The connection can be performed in various ways, such as by informing the first user of the potential second user(s) that can each perform the help service, or by informing the potential second user(s) of the first user and of the help service to be performed. The user informed of the search results may then indicate participation, such as by starting a negotiation process for performing a respective help service.

In one embodiment, connection module 312 also facilitates communication between users of the social help network. For example, any user can also respond to a help item that is posted by a first user, such as by first logging in to the social help network and then indicating participation in a posting for that help item (such as by clicking on a participate button in an application on that user's system). Any such postings can be made visible to the other user(s) (unless limited by privacy settings).

FIG. 3B is a block diagram 300 of an exemplary social help network module 302 and various support modules, according to one or more embodiments. As shown in FIG. 3B, social help network module 302 may include various support modules such as a help channel module 320, a question and answer (Q&A) module 322, an advertisement (ads) module 324, a mapping service module 326, a privacy module 328, and a data module 330, among others. It is noted that these various support modules are exemplary only, and other elements may be used in addition to, or instead of, the elements described herein. Also, as described, these modules may reside on a central server, two or more centralized servers, or they may be distributed as needed. In addition, some of the elements described may perform different, or additional services instead of what is described.

Social help network module 302 may be operable to perform one or more methods described herein, including the maintenance of the users, suggestions, geo-localization, among others. Social help network module 302 may couple and interface with the network services element, which may be operable to provide various supporting services to the network backbone, such as profile service, friend service, network service, and help service. Social help network module 302 may also access an internal database (not shown) as well as external sites in order to find information, in real-time, pertaining to the help item (e.g., the question/help request).

Social help network module 302 may be coupled to the communication channels of email, smartphone, mobile phone, web, IM, Voice, among others. Social help network module 302 may be include a real-time social search engine (as described below), but in some embodiments the real-time social search engine may be an separate component/module, as desired. Social help network module 302 may also couple to Q&A module 322 that may facilitate chatting/communication with users and/or with a robot.

For example, social help network module 302 may receive a user request, such as from a smart phone. The user request, on one end, may be interfaced with the user profile (e.g., on the social help network) that describes the user's preferences, experience, rating, privacy setting, and location, among others. This user request may be parsed to search the search engine, e.g., using one or more keywords. The user request may also be provided to Q&A module 322, which may recommend suggestions/answers (e.g., by using a robot), such as via chat, IM, and/or email, among others.

Social help network module 302 may also interface with social network layers, including existing social networks (e.g., FACEBOOK), colleagues at work, friends, friends of friends, families, commercial enterprises, any non-profit organizations, special interest groups, even strangers (depending on the privacy settings), among others. Social help network module 302 may also access any existing help items in its data module 330.

In one embodiment, social help network module 302 may operate to find the best match to a question if the help item is a help question that is posted by a first user. Social help network module 302 may determine the best match to the posted question using various factors, using analogous methodology as described with regard to flowchart 200 of FIG. 2. For example, social help network module 302 may determine a match for the help question as determined by one or more ratings for users/businesses, as well as the location of each user, the potential helpers, all placed in the context of where the help item is located. For example, if the first user from San Jose, Calif., posted a question about Tex-Mex restaurants in Austin, Tex., it may make more sense to use contacts in Austin than in San Jose to properly answer this question. As noted, a similar methodology would take place for matching a potential second user in order to propose the help service for the posted help item.

Help channel module 320 may provide much of the interface to the outside world, such as a WWW application, a messenger, email, a social application, and/or a mobile application, among others. This is how the users of the social help network may interact and access the social help services.

Ads module 324 may integrate information from social help network module 302 in various manners, including but not limited to the following:

1. Ad Listing after posting inside the chatting box. For example, this ad listing may relate to the conversation inside of the chatting box, not only as far as the content, but also locality. In addition, the rating for a help item may increase/decrease its visibility.

2. Ad listing on help item listing. For example, this ad listing may relate to a specific help request, not only as far as the content, but also locality. In addition, the rating for a help item may increase/decrease its visibility.

3. Paid listing for better visibility/connectivity. For example, this paid listing may relate to a specific help request, not only as far as the content, but also locality. In addition, the rating for a help item may increase/decrease its visibility. In other words, the rating (e.g., from ranking module 310) may also reflect the visibility for the paid listing, regardless of whether a person/business paid for a paid listing. Thus, users will be able to internally rate and classify the quality of the paid listing using the familiar social help network ratings and guidelines it uses for its ratings.

4. Integration with 3^{rd} party publisher networks. The social help network can also be integrated with 3^{rd} party publisher networks such as GOOGLE ASSENSE/AD MANAGER/DOUBLECLICK, MICROSOFT AD NETWORK, YAHOO PUBLISHER, and related KONTERA products, among others. As a result, ads module 324 may use and provide directed ads and associated services, such as ad content and frequency analysis.

Mapping service module 326 can facilitate display of a map showing geographical locations of at least a subset of the plurality of users to the first user. Social help network module 302 can then receive a selection from the first user indicating the second user from the displayed map of the closest users. In some embodiments, mapping service module 326 can also keep track and even analyze user data (e.g., anonymous data) that may be used for market analysis. For example, mapping service module 326 can gather data on the type and frequency of help requests from certain geographical areas, or the quality of help providers for a certain type of help in that certain geographical area.

Privacy module 328 may facilitate privacy setting for social help network module 302, such as whether displaying a precise location and/or name of each potential user. In one embodiment, only approximate location may be communicated to the users until both users agree to reveal this information. Data 330 may be internal and/or external data used by social help network module 302, and it may also contain a knowledge base.

### Example Use

For example, a user of the social help network may access it from a mobile phone (e.g., via an APPLE IPHONE application), such as by posting a help item (e.g., a question or a help request) to the users. The help item may be posted via the social help network. In case of a question, it can then be pre-processed by the network services, which may operate to locate the type of network, the location of the user, etc. Social help network module 302 may then process the pre-processed help request and place it on the web for the social help network, as well as access its other elements. For example, social help network module 302 may search, in real-time (or near real-time) for any recent entries on social networks, such as FACEBOOK or TWITTER. According to the results from the search, social help network module 302 may use a best match to generate/contact the best match (e.g., potential second user(s)) with the help item (question/help request). In one embodiment, privacy module 328 may ensure that the question/answers/any chats/messages pertaining to the question are only accessible according to the privacy settings set by the user. In one embodiment, ads module 324 may place ads on a social help network post/page from potentially interested users/businesses as found to be relevant to the question/help request. Ads module 324 may communicate ads and related data with advertisements, such as advertisements 116 of FIG. 1.

### Q&A Module

The social help network may build an artificial intelligence search and answer system (Q&A service), different from traditional key word oriented web search. This Q&A service may be implemented using Q&A module 322, which is communicatively coupled to social help network module 302, and may be implemented in software and/or hardware using the same server, or using one or more distributed servers, as desired. Most often, users think about their help offers/requests in natural language. Then, these natural language queries/questions usually are converted into structured search engine queries for use in a traditional web search. However, the social help network may use a search engine (e.g., that may be implemented in social help network module 302) that allows users to enter a query search (just like a traditional search engine), or ask one or more questions using an intelligent question answering system, i.e., by using natural language. Although the examples listed here are directed to questions, the Q&A service can be used to interact with the user(s) (e.g., users of the social help network) for other help items as well, such as help requests, and the help service in general, i.e., for users that would like to provide the requested help.

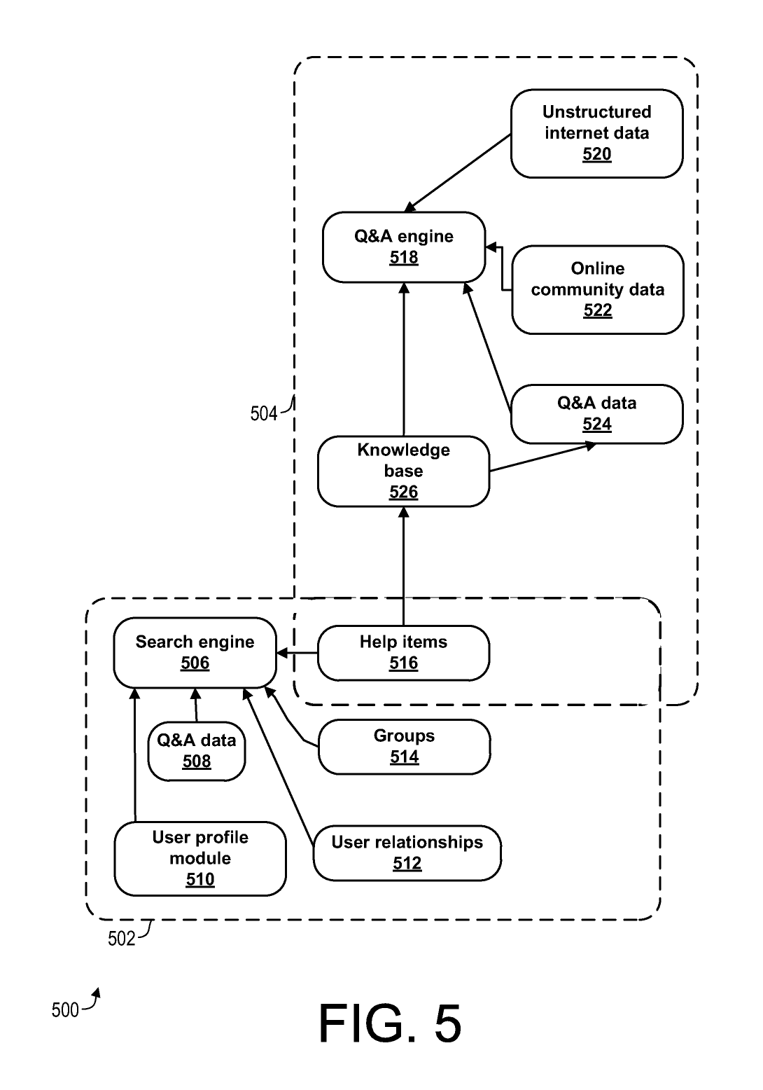

One example implementation of the Q&A service is shown in FIG. 5, according to some embodiments. Specifically, FIG. 5 is a block diagram 500 illustrating interactions between a social help network module 502 (which is an example implementation of social help network module 302) and a Q&A module 504 (which is an example implementation of Q&A module 322).

Social help network module 502 may include a search engine 506 and be able to access Q&A data 508, user profile from user profile module 510, user relationships 512, groups 514, and/or help items 516, among others. Q&A data 508 may be data that is used by Q&A module 504. User profiles 510 may be user profile data for the social help network and/or other social networks, as described in more detail below. Similarly, user relationships 512 may be indicative of various social relationships of each user in the social help network and/or other social networks. Groups 514 may indicate various groups, such as networks, in the social help network and/or other social networks. Help items 516 may be help items that have been gathered, e.g., aggregated, over the course of operation for the social help network.

Specifically, social help network module 502 may allow users of the social help network to create, modify, and use various groups 514. Groups 514 may be used to create communities of helpers for each user. These groups may be public or private. Public groups may be available to every user. Private groups may be created, and available, only to one or more users. For example, an expert group may be created for each type of a help item, such as a Java programming group, or a plumbing service group, etc. This expert group, if public, may be available to be matched with a help item, such as a help request or a help question. A public group may be a form of a help desk, except that a user is able to be matched with an answer as well as a help service. A private group may be more of a trusted network of businesses and/or friends that can answer questions and provide help services, as needed. Another use of groups may be also to facilitate communication, such as chatting.

Users are also encouraged to input their knowledge, expertise, and skills in their social help network profile, such as user profile 510. For each person in the social help network, a score may be calculated that is based on the feedback other social help network users gave, as well as the user's own engagement level (as described in the social help network score section). The social help network may also assign credibility for each user, which may be based upon the social help network score and knowledge/skills/expertise.

User profile module 510 may accumulate various types of information to build up a user profile of each user. For example, these pieces of information may include i) what user asks ii) to whom (i.e., what network) the question/help request is asked, and iii) profiles of users both requesting help, receiving help, or posting an offer to help.

For example, for a FACEBOOK click of someone associated with the social help network, user profile module 510 may note the user or friend of a user who clicked it, and if he/she is a user of the social help network, then the she/he may be added to the ratings accordingly. User profile module 510 may also research what the user searched for, researched, and/or what results were clicked on (e.g., click-through). As a result, the interest may be added to the user's profile, and thus more value for any related industry/business. Anything that the user searched for and did not click on may also be added and analyzed in order to find potential interests.

Search engine 506 may also import existing social networks from social networks, e.g., FACEBOOK, LINKEDIN, MYSPACE, among others, in order to build up an extensive social network. This will facilitate more meaningful search for help providers as well as enable other parties (e. g., individuals/businesses) to participate in any real-time communication regarding a particular topic/help item. The social help network may also facilitate inviting friends from Email/Message contact lists.

Q&A module 504 may include a Q&A engine 518 and may be able to access unstructured Internet data 520, online community data 522, Q&A data 524, and a knowledge base 526. Unstructured Internet data 520 may be data (e.g., documents) from external sources, such as from YAHOO or GOOGLE search engines. Online community data 522 may be data that has been previously created for the social help network by its users. Q&A data 524 (which may include or even be substantially the same to Q&A data 508) is data that is used and/or previously generated by Q&A engine 518. Knowledge base 526 may include a separate database of help items previously created by Q&A engine 518 and/or help items that were previously posted by users of the social help network. For example, knowledge base 526 may access help items 516 to categorize various help items 516.

Q&A engine 518 may thus combine data from various sources, including Web-based search engines, internal Q&A data, community Q&A data, as well as social help network help items. As a result, Q&A engine 518 may use different search engines including a general search engine (e.g., a YAHOO search engine) as well as its own structured data search engine (e.g., search engine 506). Q&A engine 518 may first perform a general search, e.g., to find a specific document. Q&A engine 518 may analyze deeper into this document, including providing various questions that the user may answer to provide further guidance.

Q&A engine 518 may thus search knowledge base 526 as well as documents from different data sources together, and then process them to provide a natural language answer. The social help network may build up a large knowledge base (e.g., knowledge base 526) mostly from user's personal experience and evaluation, such as from accumulated questions and answers in its user base. As a result, this knowledge base may be more subjective compared to the knowledge from sources like WIKIPEDIA, or search results obtained from search engine like GOOGLE. The social help network may also use information from WIKIPEDIA and/or GOOGLE, among other sources, as desired.

### Robot

In some embodiments, Q&A engine 518, and/or Q&A module 504 in general, may also use a software entity, referred to as a robot, which can automatically provide one or more answers and/or suggestions to help items in various forms. Users could get real-time suggestions, recommendations and/or references from web when they post the help items. Q&A engine 518 may find helpful documents that are related to a help item, and then may extract answers from these documents. In one embodiment, Q&A engine 518 may use a chatterbot element, which is an intelligent dialogue system that can interact with users based on various data such as chat history and/or contextual information, such as from the help request/messages posted in response.

The help requesters can also get receive help suggestions and/or recommendations in the form of off-line emails and/or messages. This robot can also be a chatting robot that can “jump-in” into the chat sessions like real people. Thus the robot may be able to provide chatting and messaging into various conversations started by users. In one instance the robot may be the only entity responding to a help request, and in another instance the robot may be one of two or one of several entities (such as other entities being people), that may respond to a help request.

In some embodiments, the robot may be able to provide a natural language based question and answer type of interaction. Below is an example of a user entry and subsequent parsing by the robot that uses a natural language Q&A application.

System Question 1—prompts the user to the user entry: “Questions or Keyword or phrases”

User Question 1—“What is the best Thai restaurant in Palo Alto?”

System Analysis: Keyword: Adjective—Searches out all similar/opposite sense.

Noun—Always in combination with Adjective.

Place name—Excluded from Noun

Verb—Objective

Q&A engine 518 may generate be able to use natural language queries. In other words, instead of using short key word search queries that may be used by familiar search engines, Q&A engine 518 uses queries, or even conversations, that are structured around natural language processing. The search used by the Q&A engine 518 has another distinctive aspect in that both the user who provides the answer and the answer itself are taken into consideration. The source of the knowledge is important because the credibility of the user and relationship of that user to the requesting user provides valuable information when ranking the search results.

### Search Module

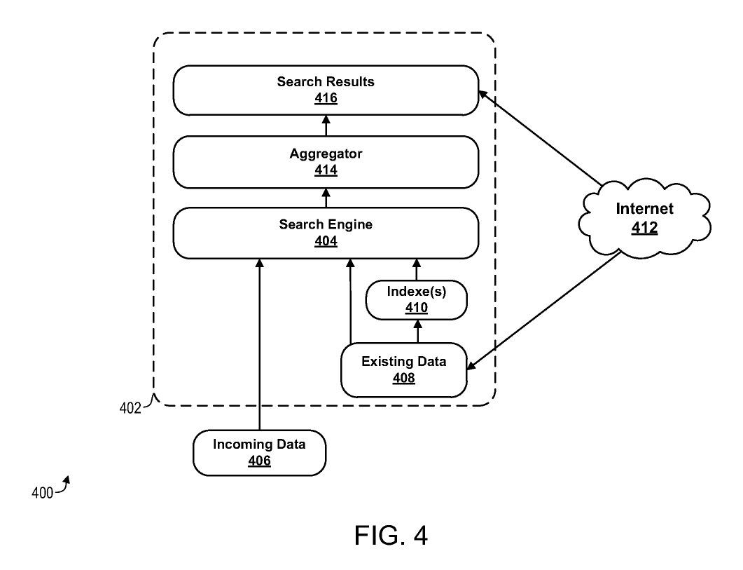

FIG. 4 is a block diagram 400 of an exemplary implementation 402 of a search module, such as of search module 308 of FIG. 3. Search module 402 can include a search engine 404 (which may be an implementation of search engine 506) that can access incoming data 406, as well as existing data 408 (that may also be indexed using one or more indexes 410). Search module 402 may also access the Internet 412. Search module 402 may also include an aggregator 414 that generates search results 414. Search module 402 can search for and find potential users of the help search network that can fulfill a help item. For example, depending on the nature of the help item, search module 402 can find potential users that can provide a help service (for a user) indicated by the help item, or can be provided with the help service (by the user) indicated by the help item, or can be connected with the user in order to communicate about the help item, etc.

Users come to the social help network web site to actively post and receive help items (help requests and help responses), so the content in the social help network is fairly dynamic. Search module 402 may operate in real-time, or near real-time, and thus any updates should be reflected within minutes from the search on the social help network website. However, traditional strategies that build a search index offline, even in a distributed way, may not be able to meet certain latency requirements, such as used by real-time, or near real-time, database searches. Instead, search module 402 may use a search engine 404 where any real-time updates are incrementally incorporated into the search results as they take place. Search engine 404 is designed with scalability in mind so that it can handle large amounts of data. Thus the search engine 404, and thus the social help network in general, provides real-time search as well as real-time connectivity between its users.

Contents for the search may be partitioned logically by time sensitiveness, meaning that content that is changing more frequently will be indexed more frequently than the content that is not changing as often. The newest contents which are not able to be indexed timely may be saved in a special format for instant search. The indexing can be done such that this portion is small enough so the instant search over this portion can be performed in real-time. As a result, it may be easy to change the logical partitioning of contents. For example, when an index reaches a predetermined limit or becomes too big for real-time search, the index can be split or shrunk to reduce the size. This assures scalability of the search system.

Based on a user posted help item (question/help request), search engine 404 may collect data from both existing data 408 and incoming data 406. Existing data 408 may be data from external search engines, such as YAHOO, BING, and/or GOOGLE, among others. Incoming data 406 may be data received in real-time from other users of the social help network, including any messages, chatting, and/or posts (e.g., using natural language Q&A sessions and user-user messaging) related to the help request. Search engine 404 may use these data sources, including building/using indexes 410 for the existing data, to intelligently search for possible potential help providers. This search will include accounting for the location of the user, the topic of the help request/question, and help providers, as well as the rankings of all parties involved.

For example, the social help network can be integrated with other social networks, e.g., FACEBOOK, TWITTER, MYSPACE, among others, to import/export users/connections. In addition, social help network module 104 can also receive and search any remarks by its users for information on the other users/help providers. For example, social help network module 104 may scan any tweets (i.e., from TWITTER) that may be directed to the quality of a potential help provider. The level of connectivity with the other social networks may be set by the user, e.g., all messages, only messages from businesses, and others. The social help network can also be integrated with search engines, such as GOOGLE, YAHOO, and/or BING, among others. Search engine 404 may use the search indexes and/or results from the search engines to complement the results of its own ranked search.

Aggregator 414 may aggregate all of the results from search engine 404 and generate search results 416 (e.g., a list of potential help providers). Search results 416 then may be returned back to the user requesting the help (or posting the question). For example, the results may be emailed/texted/IM-ed to the user in near-real time.

As used by the social help network, a real-time search may be validated in conjunction with statically indexed contents, as well as its relative relationship to each other (e.g., in parasitic manner). The value of the results from search engine 404 may be increased based on how well it defines and leverages relationships among simple real-time contents, user generated content (e.g., ratings, chat, etc.) and static content, which doesn't change over time, as well as how its notion of time and sequence is bestowed onto contents of each category. Thus, search engine 404 uses both the static contents and the real time contents, and performs an analysis of its internal attributes in a dynamically changing real-time database (such as by using incoming data 406 and/or existing data 408 and/or indexes 410) to generate useful geo-location results matching help useful and well-rated potential helpers to help requests. Search engine 404 may have both geo-location intelligence and awareness of the ratings for all users of the social help network to facilitate the help in a useful and timely manner.

Search engine 404 may thus keep track of the social relationships between users of the social help network. These relationships thus reflect the family, friends, business, and organizational structure of the networks for each user. Also, the physical location of the users is noted and used by search engine 404. For example, for a help item (e.g., a question or a help request) posted by a user for a “good carpenter,” search engine 404 would search for users/businesses that are located close by to the requester (or the destination of the request) as well as with those users/businesses that are ranked by other users in the requesting user's network/extended network(s). In case that there are no good matches, a robot for the social help network may provide suggestions based on rankings from other users, or even advertisements and/or directed marketing from businesses. Also, search engine 404 may find and connect, or at least inform, the potential help providers of the user posting the help item in their geographical area.

Search engine 404 may then search for knowledge and for people (users) who may have the knowledge/expertise to answer the help item posted by a requesting user. Search engine 404 may also search social networks for any expertise/information about what person may have it. Search engine 404 may perform this search based on the location of the user, the potential help providers, as well as the destination of the question/help request. Search engine 404 may also take into account the ratings for the potential help providers (as explained below), as well as the degree of network a potential help provider is a member.

### Rating System

Search module 308 may use rating for users and businesses according to their status, location, activity, user ratings, and others. For example, ranking module 310 may rank users of the social help network, and provide that ranking to search module 308. User rating is one of the factors that may be used by ranking module 310 to rank best matching helpers. As described, other factors include location and social ties of the users in relation to the contents of the help item as well as the poster's information. The user rating may be indicative of user's trustworthiness, or level of engagement with the social help network.

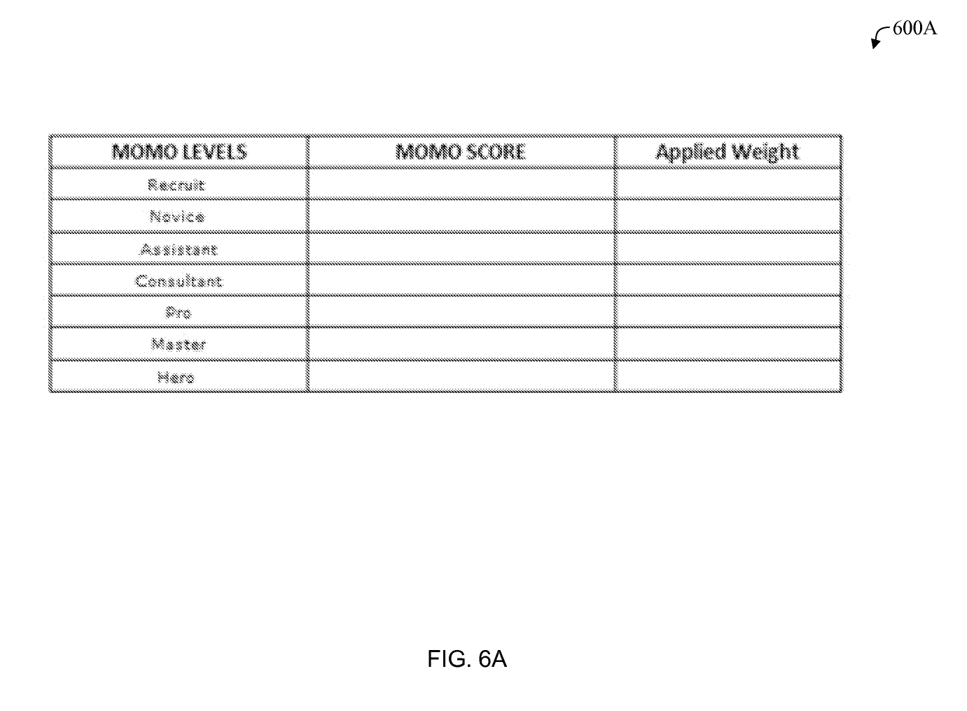

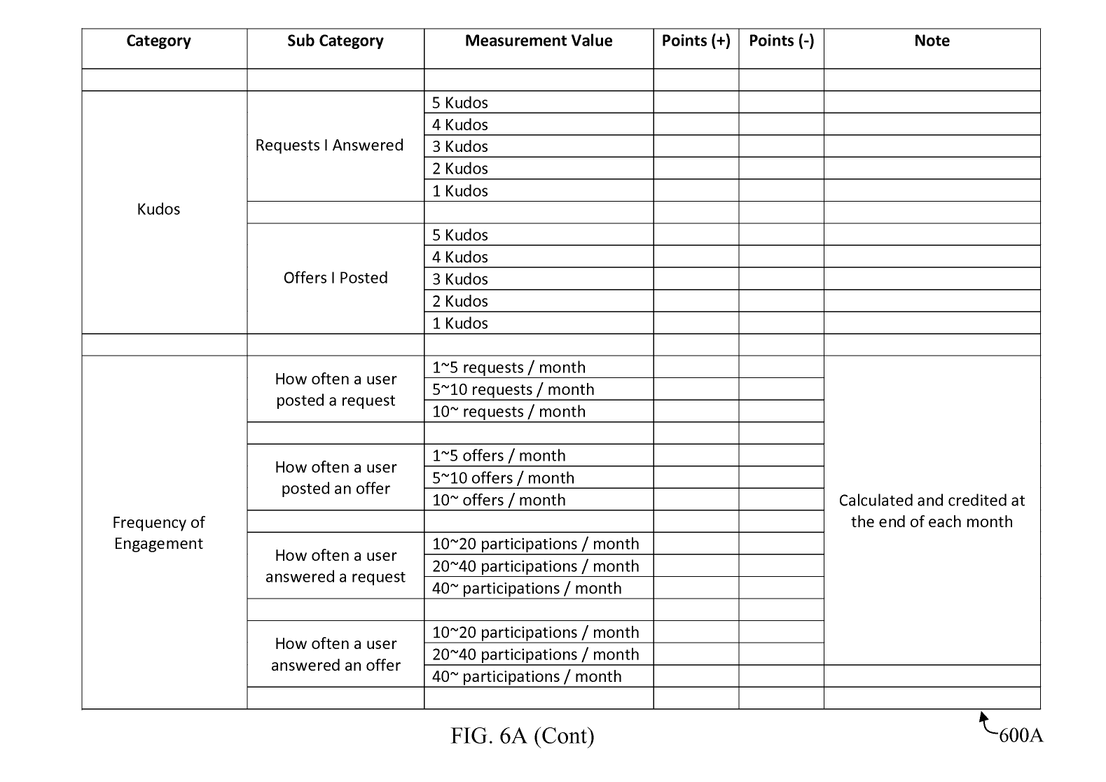

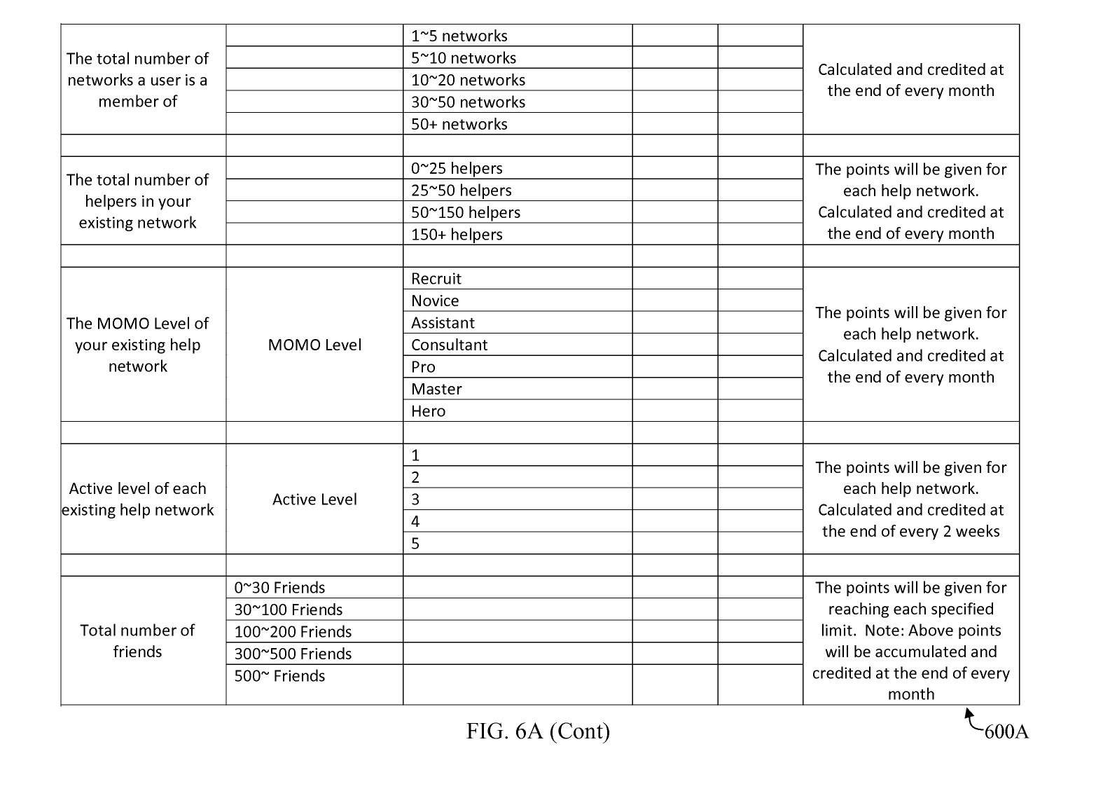

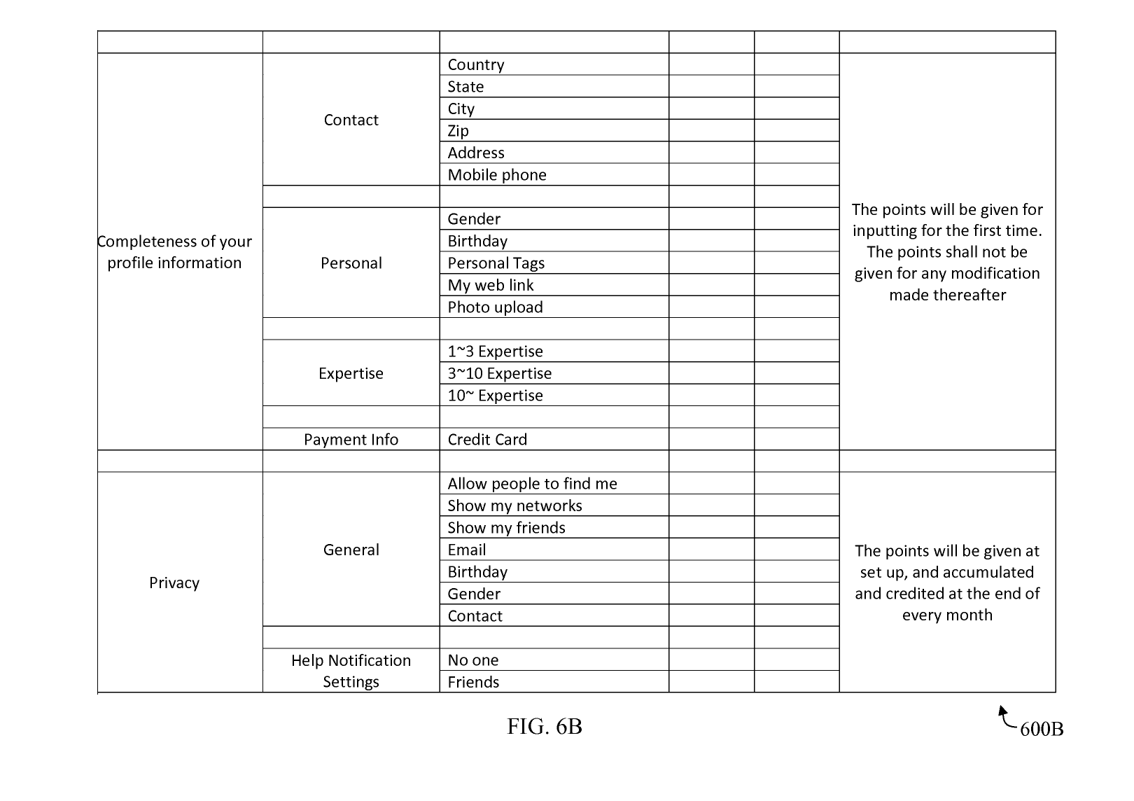

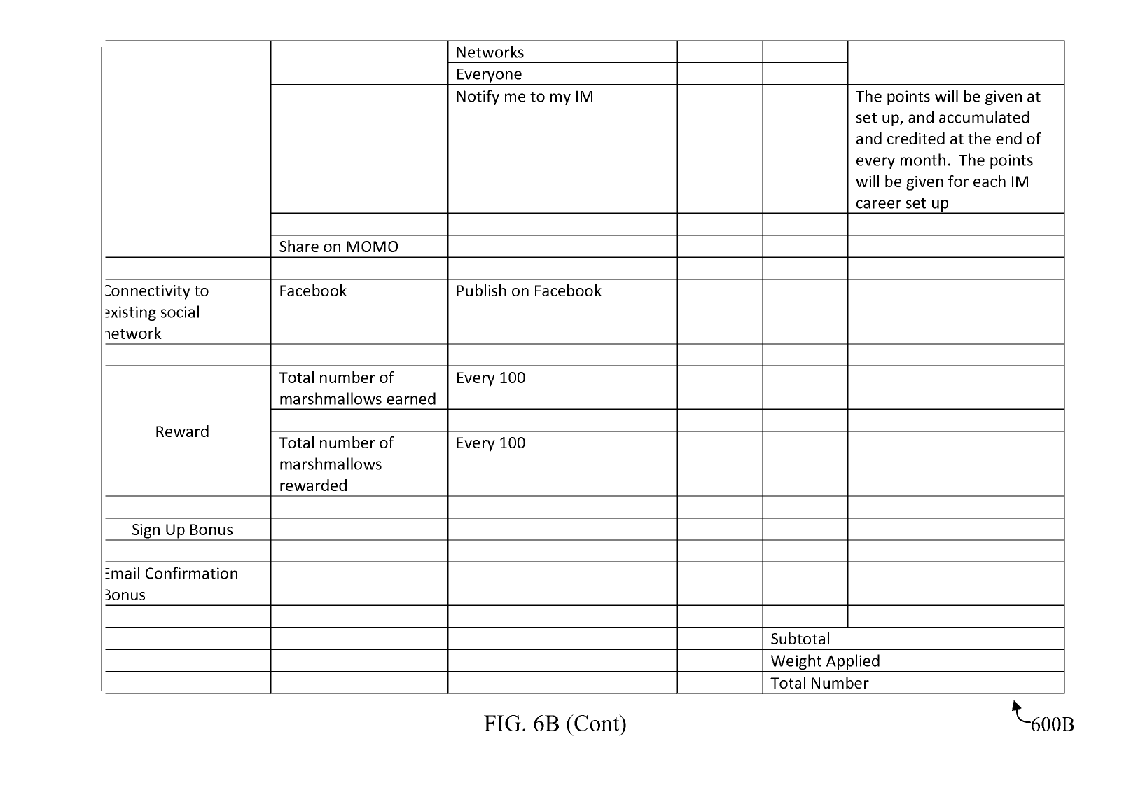

Since users of the social help network may also include businesses, these may be rated and/or ranked as well. This system-created rating may be used in ranking (e.g., by ranking module 310) for finding proper match(es) for user questions and/or help requests. The following discussion will refer to various Figs., including Tables 600 of FIGS. 6A and 6B. Table 600 illustrates various ratings, preferences, and configurations used by the system.

Ranking module 310 may use a system of levels for its users, such as a recruit, novice, assistant, etc., (as shown in the Table). It is noted that these levels are exemplary only, and other levels may be used in addition, or instead of these. Furthermore, it is noted that each of these levels may have an associated score. This score may correspond to a weight given to that user. Thus, if a search turns out two help candidates with the same locality and other features, but one has a rating of novice whereas the other one has a rating of a pro, the user with the pro rating will be given a higher visibility. Ranking module 310 operates to find the best qualified help providers for each question/help request, and the user rating helps in that aspect.

Next, ranking module 310 may use a system of Kudos (or another form of recognition/rating), where the Kudos are awarded to a user for a question answered and posted. For example, if a question/help request (i.e., help item) is well responded to or executed, the user may be awarded 4 out of 5 Kudos, whereas a badly responded to or executed help item may be only awarded 1 out of 5 Kudos. A high number of Kudos may represent a higher ranking and give more credibility to a user, while a lower number of Kudos represents a lower ranking and lesser credibility. The Kudos may also serve as a distinction of ranking and credibility from one user to another by providing one user a higher ranking over the other.

Next, ranking module 310 may note how often a user posts/answers/uses the social help system. Help items such as requests, offers, answers/responses, and services provided may be noted. The more often a user interacts with the social help system, the higher score he/she is given. This may be calculated using a running sum or at the end of a predetermined time period, such as one month.

Next, ranking module 310 may note how many other networks to which a user belongs. The higher the number of networks, such as family, professional, etc., the higher the points in this category. This may be calculated using a running sum or at the end of a predetermined time period, such as one month.

Next, ranking module 310 may note how many helpers are in a user's network (and/or extended network). This may be calculated using a running sum or at the end of a predetermined time period, such as one month.

Next, ranking module 310 may note the existing help rating of user's existing network. This help rating may be similar to the rating given to users, and may be some form of an average/weighted average given to the connections in a user's first, or extended network. This may be calculated using a running sum or at the end of a predetermined time period, such as one month.

Next, ranking module 310 may note the level of activity (e.g., posting or answering and/or servicing help items) for the connections in a user's network. This makes a difference as not all connections will be as helpful as others. This may be calculated using a running sum or at the end of a predetermined time period, such as one month.

Next, ranking module 310 may note the total number of friends in a user's connections. This may be calculated using a running sum or at the end of a predetermined time period, such as one month. This element, as well as others, may have an extra credit given for reaching certain thresholds, such as having 100, 250, 500, and 1000 friends/connections.

Next, ranking module 310 may note the completeness of a user's profile. In some embodiments, points may only be given for completing the profile the first time. However, points may also be given for completing the profile at a later time.

Next, ranking module 310 may note the privacy settings for a user. Points may be awarded for various settings, such as general (who can see the user and what information is visible), help notification settings (who can see help requests/questions), and whether the user can be connected via an instant messenger (IM). Connectivity to social networks and other sources may be accounted as well. This privacy setting may, for example, limit access of other users to messaging/chatting (e.g., open v. closed conversations).

Next, ranking module 310 may note the total number of the virtual currency and/or rewards that was earned by the user. The higher each one of these categories, the more points may be awarded. Generally, the social help network allows users to reward the helpers in the form of virtual gifts, virtual currency, real money (e.g., by using PAYPAL or credit cards) or electronic gift cards, or any kind of object in value. The virtual currency may be referred to as marshmallows and be shown as such on the screen (e.g., in the user's profile page).

Next, ranking module 310 may add up the points for all of the above categories, and may weight each category as desired. The weighted point total then may be used to calculate the social help network level for the user. As described, this network level then may be used in better determining the potential match, e.g., by assigning users with a higher network level more credibility and/or visibility in the results section.

There may be other categories in addition to the ones described above, as this serves an exemplary purpose only.

### Mobile Applications

The social help network may be easily accessed by mobile applications, such as applications for mobile phones, including smart phones such as the APPLE IPHONE, any RIM BLACKBERRY DEVICE, any mobile phone running the GOOGLE ANDROID operating system, any mobile phone running the MICROSOFT WINDOWS MOBILE operating system, any mobile phone running the NOKIA SYMBIAN operating system, among others; other mobile phones (e.g., “feature phones”) that allow internet and/or connectivity to the social help network; any PALM OS or comparable based personal organizer; any tablet computer; any netbook computer; as well as personal laptop computers such as based on the MICROSOFT WINDOWS, APPLE, and UNIX operating systems, among others. The social help network can also be easily accessed using desktop computers; gaming systems, such as NINTENDO, MICROSOFT, and SONY video game consoles, among others; as well as any other device such as mobile internet in cars, including the BMW, AUDI, MERCEDES, FORD multimedia access systems, among others.

FIGS. 7A-7D illustrate examples of an IPHONE application that the user can use to access the social help network. As described, users can post and receive help items, as well as chat/message/IM using the IPHONE application, which may interface with user module 304. As described herein, the mobile application may be used by both the help requesters and the help providers. It is noted that the same user may be a help requester at one time, and a help provider at another time. Users may be able to access and change their own settings, such as privacy, network, and others. In some embodiments, user module 304 of FIG. 3A may facilitate communication of social help network module 302 with the mobile application(s) described herein.

Thus, a help item, such as a help request, may be posted by a user using a mobile device via a mobile application. This request may then be sent to the central server(s) for the social help network (e.g., to user module 304). Once the social help network determines potential help providers, the one or more help providers may be informed (e.g., via user module 304) of the question/help request, such they may be able to answer it and contact/communicate with the user requesting the help in real-time. In some embodiments, connection module 312 may facilitate the connections between the users of the social help network.

For example, as shown in FIG. 7D, a graphical user interface (GUI) 700D of an exemplary mobile application may display a top bar area 702, a tab bar area 704, a main area 706, action links 708, and a bottom bar 710, among others. Top bar area 702 may be used (e.g., by a user of the mobile device that displays the GUI) to search for any help item, such as a request/offer. Tab bar area 704 may be used to set a chat/edit/location mode of operation. Main area 706 may be used to display posts/user profiles/status of help items/maps of potential helpers/providers, etc. Action link area 708 may be used to display various actions such as select participants, finalize participants, close a current help item/window/area, cancel the same, etc. Bottom bar area 710 may be used to switch between various modes such as looks for friends/networks/settings/search for users/help/etc.

In addition, in some embodiments, the users may be able to post questions/help requests and provide answers/suggest services using one or more social networks or other channels. For example, the user may post a question using TWITTER, and if the user is a member of the social help network, the social help network may process this question/help request (e.g., using user module 304) as if it was posted using a stand-alone social help network application. The user may also use other channels for communicating with the social help network, such as FACEBOOK, IM, or even texting a dedicated number associated with the social help network, or emailing the question/help request into the social help network. Thus the user is not limited by the type of channel available to him/her.

Similarly, once social help network module 302 searches for and finds one or more potential help providers, they can be contacted using any of the one or more channels available to those potential help providers, e.g., such as configured using the mobile application. Once a potential help provider answers this communication from the social help network, they may contact the requesting user directly, or they may contact the requesting user through the messaging/chatting services provided by the social help network. As a result, user module 304 may continue to monitor the communication between the users. As described herein, social help network module 302 may also provide a robot (e.g., via Q&A module 322) that can jump-in and communicate suggestions and/or answers to the users.

### Sample Application

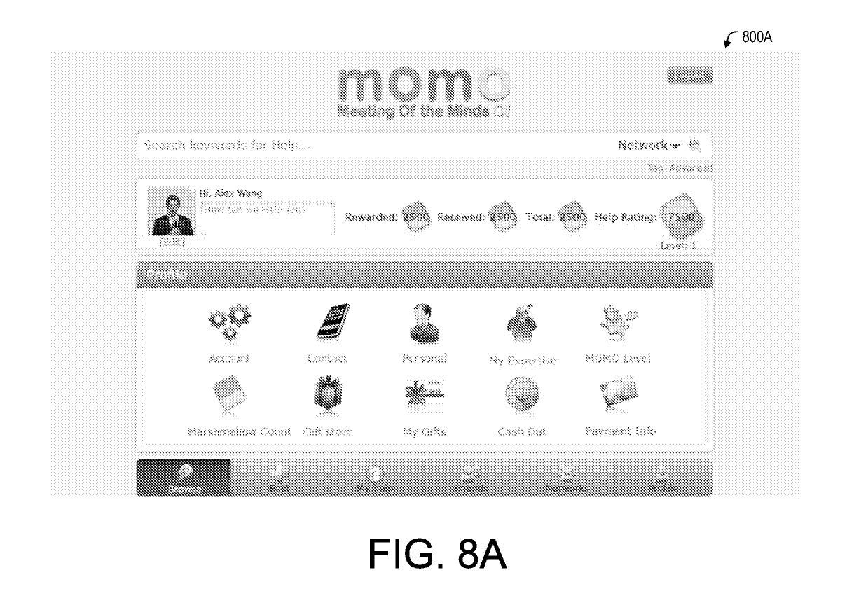

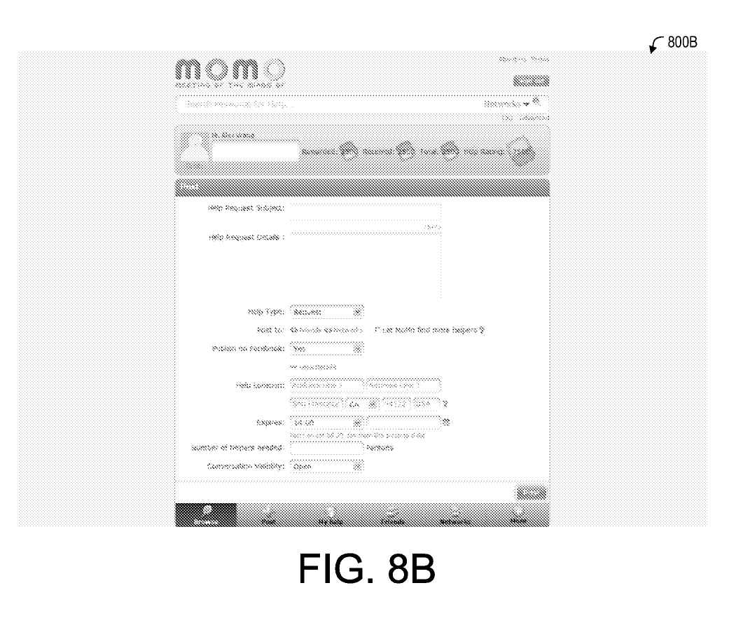

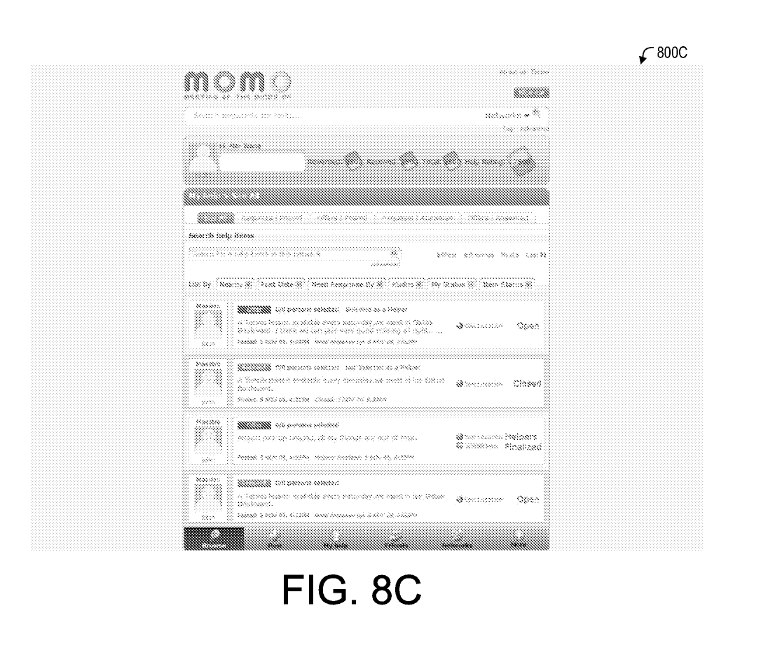

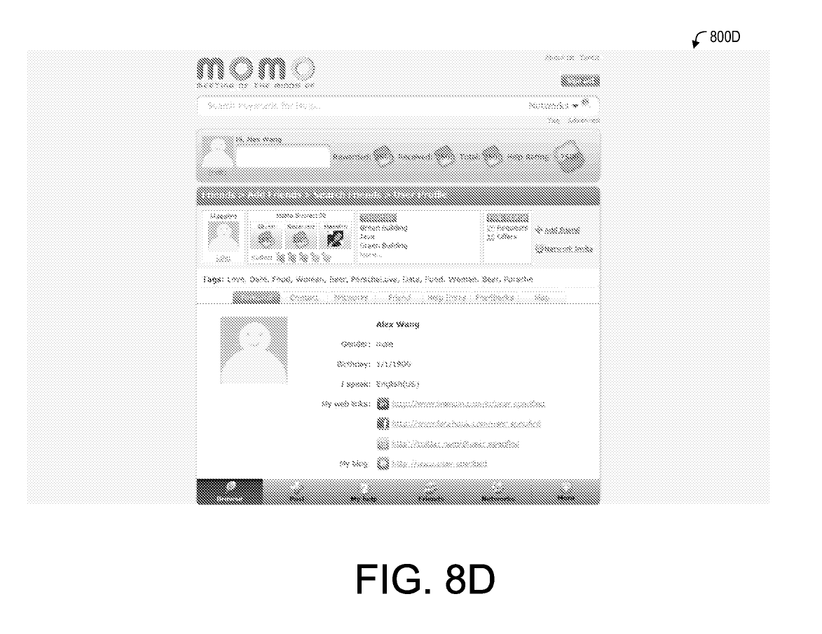

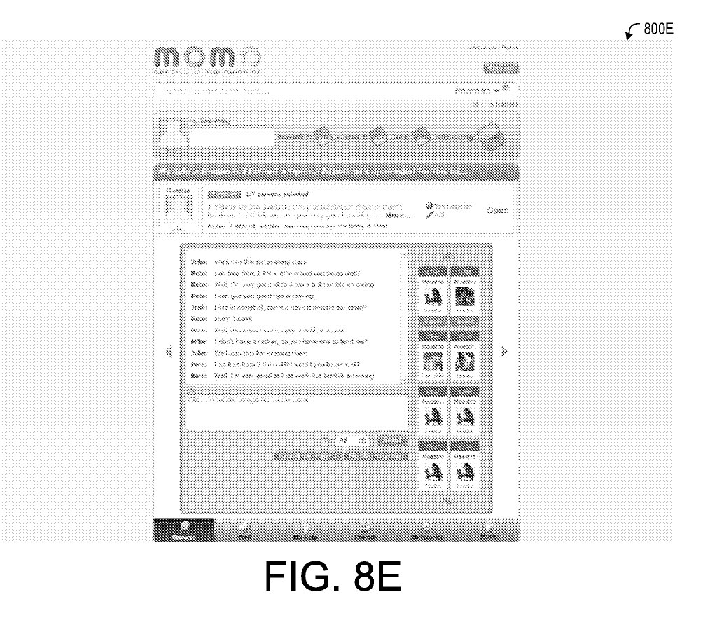

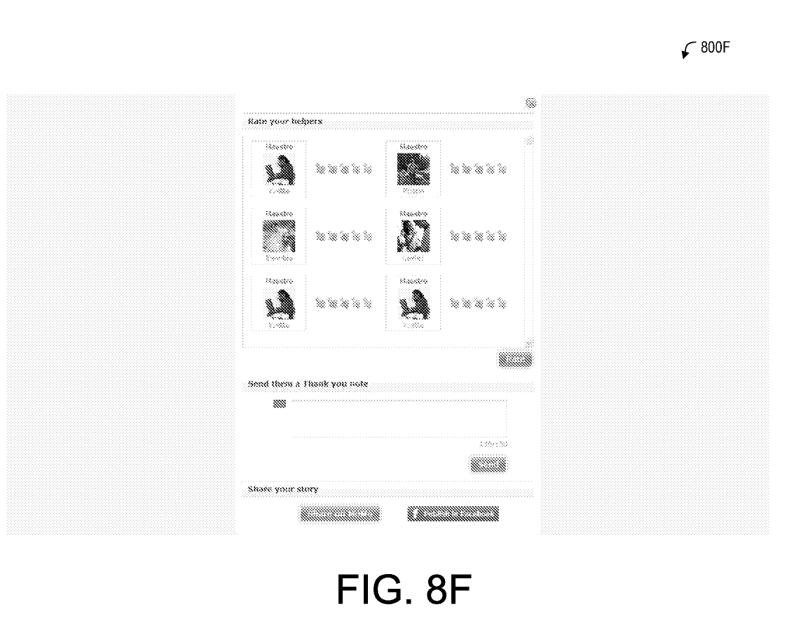

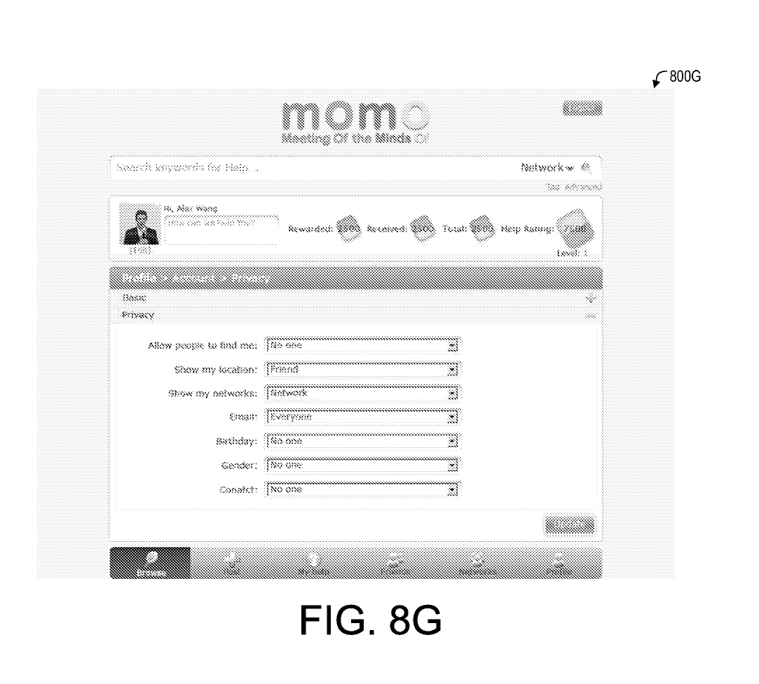

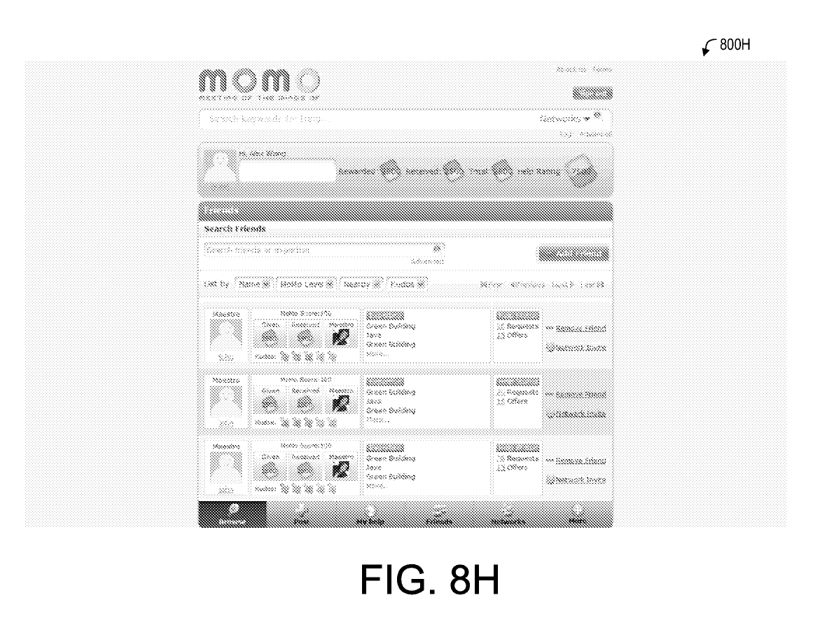

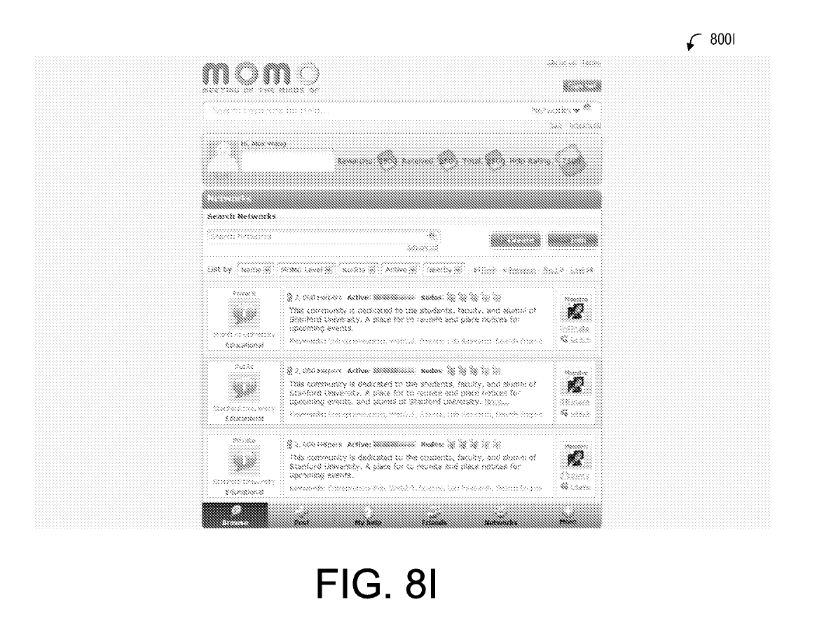

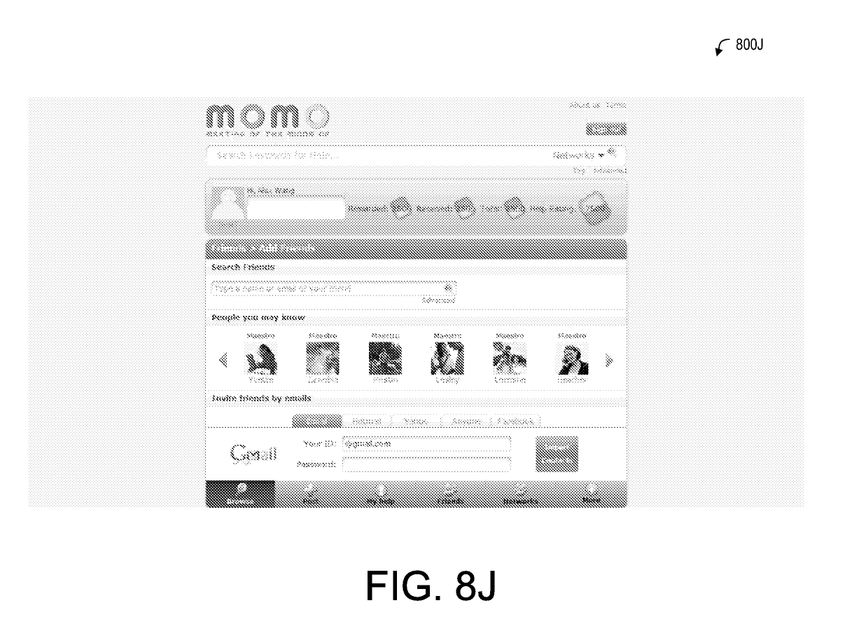

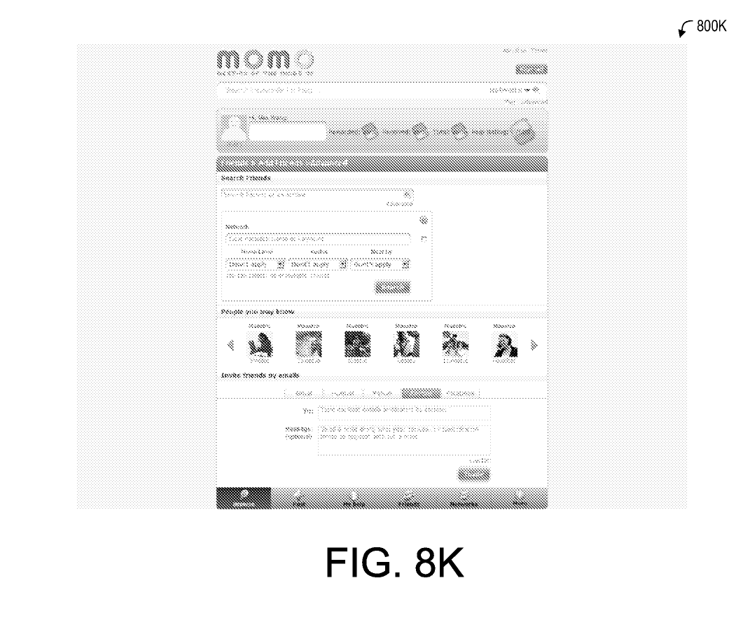

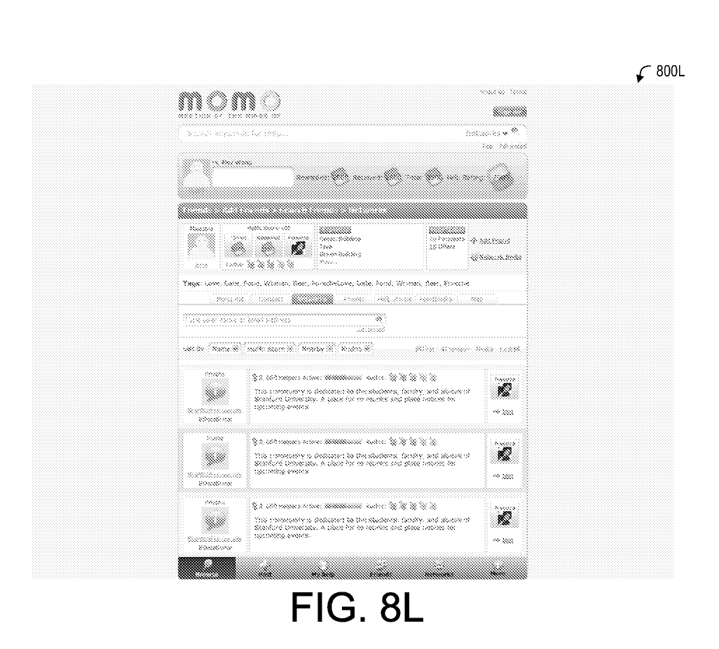

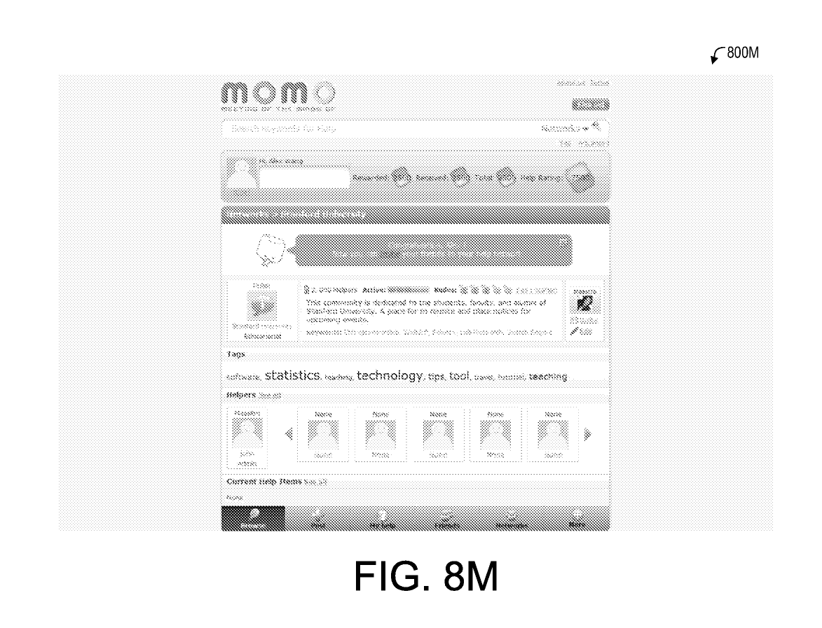

FIGS. 8A-8M show illustrative screenshots of an exemplary application that can be used by a user to access the social help network, e.g., via user module 304. It is noted that the application and/or the social network may provide different functionality, as desired. It is also noted that most of the information below may be posted to social networks, such as FACEBOOK, TWITTER, MYSPACE, LINKEDIN, among others. As described, the options and functionality described below may interact with and be used by the social help system.

FIG. 8A shows an exemplary screenshot of a user profile of a user. From this screen, the user may be able to access account, contact, personal, momo (social help network) level, marshmallow count (i.e., virtual currency), gift store, my gifts, cash out, and payment information. Also, the user profile may show the location of one or more help requests posted, as well as the location of one or more suggested help providers. This location information may be filtered, such as by topic of a help request.

FIG. 8B shows an exemplary screenshot of a user post, such as a question or (as in this case) a help request. The user can specify where to post to a specified group of friends or networks, and receive help/answers from them. Alternatively, the user can specify that the social help network (e.g., momo) can find helpers, as described above. The user may specify in the settings whether a robot can jump in and provide suggestions, even for a case where the social help network does not search for (and possibly contact) helpers. The user may specify the location of the user, and possibly the location where the help/question is directed, besides other options. In addition, the user post for a help item (e.g., a question or a help request) may contain a proposed reward paradigm for this operation, such as marshmallows (virtual currency), virtual gifts, real money, electronic gift cards, and/or any other object(s) with value, including an “I owe you” for any of these rewards or a promise to provide help for a similar help item.

FIG. 8C shows an exemplary screenshot of a history of questions/help requests/help provided for the user. As shown, there are various options for filtering and sorting of these help items. In addition, this feature may show the location of all of the helpers and well as where the help was requested. This historical location information for help requests may be filtered, such as by topic of a help request.

FIG. 8D shows an exemplary screenshot of a friend's user profile, including his personal information, contacts, as well as help items and feedback information.

FIG. 8E shows an exemplary screenshot of detailed information for one of requests posted by the user. The chatting/messaging history may be shown, along with potential help providers (e.g., provided by the social help network or manually provided by the selected network/friends).

FIG. 8F shows an exemplary screenshot of a rating screen for users and/or helpers, including an option to send a thank you note. For example, the ratings may be expressed using kudos, which can later be used by the social help network to determine the level for each user.

FIG. 8G shows an exemplary screenshot of privacy settings for a user. For example, the user may be able to specify who can find him/her, who can see/use user's location, who can see the user's networks, along with other information shown. Also, the user can set networks and/or communities to be private or public, thus setting access and visibility.

FIGS. 8H-8M show various exemplary screenshots for searching for friends, adding friends, searching networks, and inviting friends from own or other people's networks. As shown, there may be various filters and criteria that may be used to better find contacts. Also, the user may be able to search on status of users to find certain people/businesses. The user may be able to create own networks, and assign these networks with keywords/tags that may be useful for own searches, as well as searches by others.

### Virtual Currency

Virtual currency (e.g., marshmallows) described above may be used for transactions, such as user to user and/or business to user. This virtual currency can be bought using real money, and thus used for transactions. However, the help social network can also award certain users virtual currency based on the amount of help/ratings/goodwill they generated among other users. For example, someone that gave 100 good answers to other people's help requests, such as by using the chat/messaging feature, may be awarded some value of virtual currency. This way the Kudos feature described below may be utilized.

The virtual currency can be exchanged with other existing virtual currency platform. This feature allows the users of the social help network to share (i.e., use or give) virtual currencies from/to other platforms, such as the MICROSOFT XBOX, SONY PLAYSTATION, NINTENTO, etc. Users of the social help network can also sell and receive virtual gifts. These can range from virtual currency gifts and service coupons to more intangible items, such as virtual gifts (e.g., virtual teddy bears). Users of the social help network can also use the virtual currency to purchase gift cards that can be used to purchase services from businesses and individuals.

### Other Users of the Social Help Network

The social help network may be used by various types of users. It may be used in a consumer-to-consumer setting, such as individual users posting questions and help requests that may be answered by other consumers. For example, one customer may help another customer with their impression of particular service providers in a given geographical area. The social help network may also be used in various consumer-business settings, where businesses may answer and/or suggest their own services to the user posting a question/help request. Another example is a service platform for businesses, where a company, such as DELL, can monitor questions/help requests posted by users (e.g., if the user has that company in its network) and provide answers (e.g., by using the chatting/messaging services) or suggest a help service. As discussed above, a user may be able to change his or her settings, such as using privacy settings, thus including or excluding all or some part of visibility to businesses. In addition, the social help network may facilitate delivery of advertisements and other direct marketing to the user, as determined by the question/help request. As noted above, one or more of the items delivered to the user may be also filtered/searched for by the location and/or rating for the user and the potential help providers. In addition, the social help network may inform, such as by IM, email, etc., the potential help providers of a certain user question/help request.

Therefore the social help network is able to match the people needing help with those people/businesses that can provide that help. For example, the potential help providers are informed, in real-time, of a question/help request that they may be able to help with. In other words, the social help network works both ways, it helps the requesting people needing help, and it also can help (with getting business) the people/businesses that can provide a service needed by the help requesters.

Social help network module 104/302, help channel module 320, Q&A module 322, ads engine 324, mapping service 326, privacy module 328, data 330, search module 402, social help network module 502 and Q&A module 504, and/or any sub-modules therof, may be implemented in hardware, software, firmware, or any combination thereof. For example, social help network module 104/302 may be implemented as computer program code configured to be executed in one or more processors. In another example, social help network module 104/302 may be implemented as hardware logic/electrical circuitry.

### Example Computer Implementation

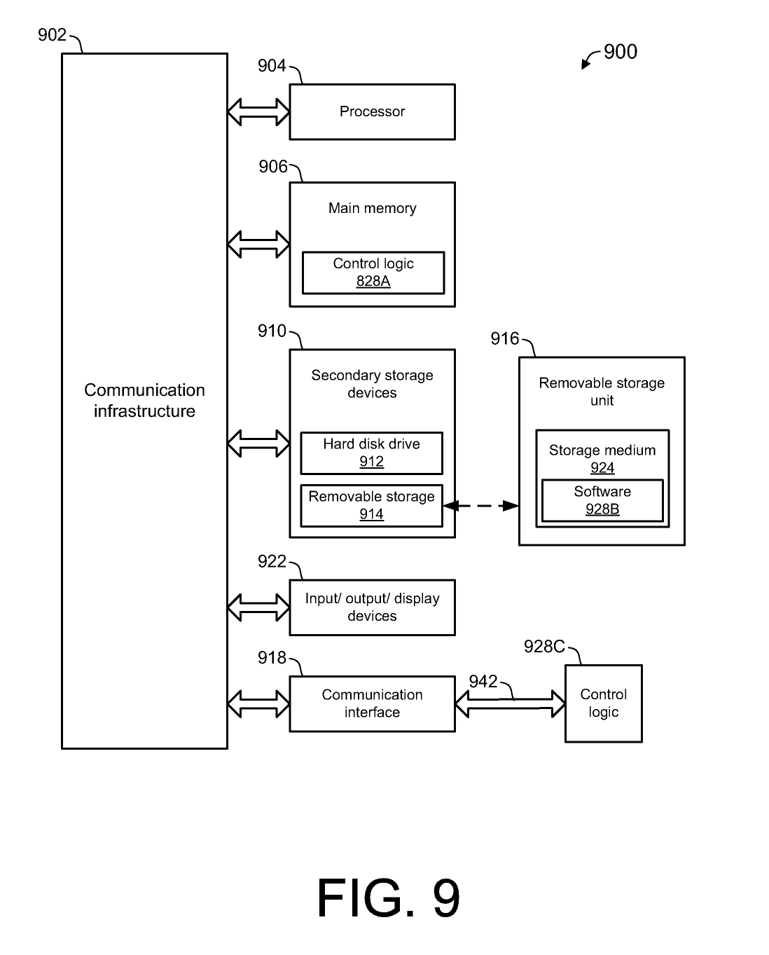

The embodiments described herein, including systems, methods/processes, and/or apparatuses, may be implemented using well known servers/computers, such as computer 900 shown in FIG. 9. For instance, elements of example network 100, including any of the server(s) 102, user systems 106A-106B, depicted in FIG. 1 and elements thereof, each of the steps of flowchart 200 depicted in FIG. 2, can each be implemented using one or more computers 900.

Computer 900 can be any commercially available and well known computer capable of performing the functions described herein, such as computers available from International Business Machines, Apple, Sun, HP, Dell, Cray, etc. Computer 900 may be any type of computer, including a desktop computer, a server, tablet PC, or mobile communication device, etc.

As shown in FIG. 9, computer 900 includes one or more processors (e.g., central processing units (CPUs)), such as processor 906. Processor 906 may include social help network module 104 of FIG. 1; social help network module 302, help channel module 320, Q&A module 322, ads engine 324, mapping service 326, privacy module 328, data 330, of FIG. 3A/3B; search module 402, of FIG. 4; social help network module 502 and Q&A module 504, of FIG. 5, and/or any portion or combination thereof, for example, though the scope of the embodiments is not limited in this respect. Processor 906 is connected to a communication infrastructure 902, such as a communication bus. In some embodiments, processor 906 can simultaneously operate multiple computing threads.

Computer 900 also includes a primary or main memory 908, such as a random access memory (RAM). Main memory has stored therein control logic 924A (computer software), and data.

Computer 900 also includes one or more secondary storage devices 910. Secondary storage devices 910 include, for example, a hard disk drive 912 and/or a removable storage device or drive 914, as well as other types of storage devices, such as memory cards and memory sticks. For instance, computer 900 may include an industry standard interface, such as a universal serial bus (USB) interface for interfacing with devices such as a memory stick. Removable storage drive 914 represents a floppy disk drive, a magnetic tape drive, a compact disk drive, an optical storage device, tape backup, etc.

Removable storage drive 914 interacts with a removable storage unit 916. Removable storage unit 916 includes a computer useable or readable storage medium 918 having stored therein computer software 924B (control logic) and/or data. Removable storage unit 916 represents a floppy disk, magnetic tape, compact disc (CD), digital versatile disc (DVD), Blue-ray disc, optical storage disk, memory stick, memory card, or any other computer data storage device. Removable storage drive 914 reads from and/or writes to removable storage unit 916 in a well known manner.

Computer 900 also includes input/output/display devices 904, such as monitors, keyboards, pointing devices, etc.

Computer 900 further includes a communication or network interface 920. Communication interface 920 enables computer 900 to communicate with remote devices. For example, communication interface 920 allows computer 900 to communicate over communication networks or mediums 922 (representing a form of a computer useable or readable medium), such as local area networks (LANs), wide area networks (WANs), the Internet, etc. Network interface 920 may interface with remote sites or networks by using wired or wireless connections. Examples of communication interface 922 include but are not limited to a modem, a network interface card (e.g., an Ethernet card), a communication port, a Personal Computer Memory Card International Association (PCMCIA) card, etc.

Control logic 924C may be transmitted to and from computer 900 by using the communication medium 922.

Any apparatus or manufacture comprising a computer useable or readable medium having control logic (software) stored therein is referred to herein as a computer program product or program storage device. This includes, but is not limited to, computer 900, main memory 908, secondary storage devices 910, and removable storage unit 916. Such computer program products, having control logic stored therein that, when executed by one or more data processing devices, cause such data processing devices to operate as described herein, represent embodiments of the invention.

For example, each of the elements of social help network module 104 depicted in FIG. 1; social help network module 302; help channel module 320, Q&A module 322, ads engine 324, mapping service 326, privacy module 328, data 330, depicted in FIG. 3; search module 402 depicted in FIG. 4; social help network module 502 and Q&A module 504, depicted in FIG. 5, can be implemented as control logic that may be stored on a computer useable medium or computer readable medium, which can be executed by one or more processors to operate as described herein.

### CONCLUSION

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

We claim:

1. A method for operating a social help network, the method comprising:
receiving a help item from a first user of a social help network, wherein the help item indicates a help service that is to be performed for the first user by a second user or by the first user for the second user, wherein the social help network includes a plurality of users including the first user and a plurality of potential second users that includes the second user;
determining one or more factors of the first user including a geographical location of the first user;
determining one or more factors of the help item including a geographical location where the help service is to be performed;
determining one or more factors of at least a subset of the plurality of users including a geographical location of each of the subset of users; and
based on the factor(s) of the first user, the factor(s) of the help item, and the factor(s) of the subset of users, searching, using one or more processors, for one or more potential second users that each can perform the help service indicated by the help item for the first user or for one or more potential second users for whom the first user can perform the help service indicated by the help item.

2. The method of claim 1, wherein the factor(s) of the first user include one or more of:
a geographical location of the first user;
a profile information for the first user;
a trust worthiness score indicative of at least how active the first user is in the social help network; or
previous one or more posted help items by the first user.

3. The method of claim 1, wherein said receiving the help item comprises the first user posting the help item on the social help network, wherein the factor(s) of the help item include one or more of:
a geographical location of where the help service is to be performed;
a bid for the help item that indicates a desired value for the help service;
a title of the help item;
a description of the help service; or
one or more requirements of the help service to be performed.

4. The method of claim 3, further comprising:
the first user receiving communication from another user via the social help network regarding the help item; and
automatically modifying one more of the factor(s) of the help item in response to receiving the communication.

5. The method of claim 1, wherein the factor(s) of at least a subset of the users further include, for each user, one or more of:
a geographical location of that user;
a profile information for that user;
a strength of a social network relationship of that user to the first user;
a trust worthiness score indicative of at least how active that user is in the social help network; or
previous one or more posted help items by that user.

6. The method of claim 5, further comprising:
ranking each of at least a subset of the users based on a relation between one or more of the factor(s) of the first user, factor(s) of the help item, or factor(s) of each of at least a subset of the users.

7. The method of claim 6, further comprising:
presenting to the first user one or more highest ranked users that have a higher ranking relative to other users based on said ranking.

8. The method of claim 6,
wherein said ranking accounts for proximity of respective geographical location of the first user, where the help service is to be performed, and each ranked user.

9. The method of claim 1, further comprising:
connecting the first user with the potential second user(s) based on results of said searching for the potential second user(s), wherein said connecting includes one or more of informing the first user of the potential second user(s) that can each perform the help service or informing the potential second user(s) of the first user and of the help service to be performed.

10. The method of claim 1, further comprising:
receiving a selection from the first user indicating the second user out of the potential second user(s).

11. The method of claim 1, further comprising:
displaying a map showing geographical locations of at least a subset of the plurality of users to the first user; and
receiving a selection from the first user indicating the second user from the displayed map of the closest users.

12. The method of claim 1, further comprising:
filtering out a subset of users from the plurality of users, where each user in the subset of users has a social relationship score that is below a social threshold, wherein the social relationship score for each user is indicative of a strength of a social tie in one or more of the social help network or other social networks between that user and the first user.

13. A system for operating a social help network, the system comprising:
a user module operable to receive a help item from a first user of a social help network, where the help item indicates a help service that is to be performed for the first user by a second user or by the first user for the second user, where the social help network includes a plurality of users including the first user and a plurality of potential second users that includes the second user;
a factor determination module operable to:
determine one or more factors of the first user;
determine one or more factors of the help item; and
determine one or more factors of at least a subset of the plurality of users; and
a search module operable to search, based on the factor(s) of the first user, the factor(s) of the help item, and the factor(s) of the subset of users, for one or more potential second users that each can perform the help service indicated by the help item for the first user or for one or more potential second users for whom the first user can perform the help service indicated by the help item.

14. The system of claim 13, wherein the factor(s) of the first user include one or more of:
a geographical location of the first user;
a profile information for the first user;
a trust worthiness score indicative of at least how active the first user is in the social help network; or
previous one or more posted help items by the first user.

15. The system of claim 13, wherein the user module is operable to post the help item from the first user on the social help network, wherein the help service indicated by the help item includes one or more of:
a geographical location of where the help service is to be performed;
a bid for the help item that indicates a desired value for the help service to be performed;
a title of the help item; or
a description of the help service to be performed.

16. The system of claim 13, wherein the one or more factors of at least a subset of the users further include, for each user:
a geographical location of that user;
a profile information for that user;
a strength of a social network relationship of that user to the first user;
a trust worthiness score indicative of at least how active that user is in the social help network; or
previous one or more posted help items by that user.

17. The system of claim 13, further comprising:
a ranking module operable to rank each of at least a subset of the users based on a relation between one or more of the factor(s) of the first user, factor(s) of the help item, or factor(s) of each factors of at least a subset of the users.

18. The system of claim 17, wherein the user module is further operable to present to the first user one or more highest ranked users that have a higher ranking relative to other users based on said ranking.

19. The system of claim 13, further comprising:
a connection module operable to connect the first user with the potential second user(s) based on results of the search for the potential second user(s), wherein the connection includes one or more of informing the first user of the potential second user(s) that can each perform the help service or informing the potential second user(s) of the first user and of the help service to be performed.

20. A computer program product comprising a computer-readable medium having computer program logic recorded thereon for operating a social help network, the computer program logic comprising:
first means for enabling a processor to receive a help item from a first user through use of a social help network, where the help item indicates a help service that is to be performed for the first user by a second user or by the first user for the second user, where the social help network includes a plurality of users including the first user and a plurality of potential second users that includes the second user;
second means for enabling a processor to determine one or more factors of the first user;
third means for enabling a processor to determining one or more factors of the help item;
fourth means for enabling a processor to determining one or more factors at least a subset of the plurality of users; and
fifth means for enabling a processor to search, based on the factor(s) of the first user, the factor(s) of the help item, and the factor(s) of the subset of users, for one or more potential second users that each can perform the help service indicated by the help item for the first user or for one or more potential second users for whom the first user can perform the help service indicated by the help item.
